(19) United States
(12) Patent Application Publication
(10) Pub. No.: US 2023/0071028 A1
(43) Pub. Date: Mar. 9, 2023

(54) NANOPARTICLE POLYELECTROLYTE NETWORK FILMS AND METHODS OF MAKING SAME

(71) Applicant: GUIN TECHNOLOGIES LLC, Tuscaloosa, AL (US)

(72) Inventor: Tyler Caldwell Guin, Aiken, SC (US)

(21) Appl. No.: 17/794,084

(22) PCT Filed: Jan. 22, 2021
(86) PCT No.: PCT/US21/14645

§ 371 Date: Jul. 20, 2022

Related U.S. Application Data
(60) Provisional application No. 63/007,485, filed on Apr. 9, 2020.
(60) Provisional application No. 62/965,427, filed on Jan. 24, 2020.

(51) Int. Cl. A01N 43/36; A01P 1/00; C09D 5/14; C09D 7/20; C09D 7/61; C09D 7/40; C09D 139/02; C09D 133/02; C09D 179/02; C09D 125/18

(52) U.S. Cl. CPC A01N 43/36; A01P 1/00; C09D 5/14; C09D 7/20; C09D 7/61; C09D 7/67; C09D 139/02; C09D 133/02; C09D 179/02; C09D 125/18

(57) ABSTRACT

Compositions for forming coatings disclosed herein can include a cationic polyelectrolyte, an anionic polyelectrolyte, nanostructures, and a crosslinking agent. The compositions, coatings, methods, and kits described herein can have improved tribological properties, hardness, and strength.

### CROSS-REFERENCE TO RELATED APPLICATIONS

This application claims the benefit of the filing date of U.S. Provisional Application No. 62/965,427, filed Jan. 24, 2020, and U.S. Provisional Application No. 63/007,485, filed Apr. 9, 2020, the disclosures of which are hereby incorporated by reference in their entireties.

### STATEMENT OF GOVERNMENT INTEREST

This invention was made with Government support under Contract No. DE-AC05-00OR22725 awarded by the United States Department of Energy. The Government has certain rights in this invention.

### BACKGROUND

### Field of the Disclosure

The disclosure generally relates to compositions for forming a coating. The compositions can include an anionic polyelectrolyte, a cationic polyelectrolyte, nanostructures, and a crosslinking agent. The disclosure further relates to methods of preparing and using the compositions of the disclosure, methods of forming coatings from the compositions of the disclosure, and kits for preparing the same.

### Brief Description of Related Technology

Polyelectrolyte (PE) coatings have garnered interest in a wide variety of applications, such as in gas barriers, flame retardance, lubrication, anti-fouling, microelectronics, and other areas due, in large part, to their unique molecular architecture enabled by strong electrostatic interactions in their molecular structure. However, commercial development of these materials in film form has been limited by drawbacks associated with the primary technique for formation of the same in film or coating form, known generally as the layer-by-layer assembly (LbL) technique, and by the multiple and relatively complex deposition steps (typically>100) required in LbL methods. Other drawbacks with known PE film compositions include their relatively poor mechanical properties for many applications, their relatively poor moisture resistance, and other performance issues.

Effective inclusion of nanostructures in PE films has the potential to greatly enhance the utility of such films, but efforts to do so have been met with limited success due to the strong tendency of the nanostructures to aggregate into agglomerates, especially in aqueous mixtures. To combat the aggregation of nanostructures, efforts have been made to functionalize the nanostructures, for example with oxidative or reductive groups, which can improve dispersibility of the nanostructures. However, functionalization introduces defects in the nanostructures, which can diminish their beneficial physical properties.

Efforts have also been made to limit aggregation of nanostructures, for example by the addition of organic solvents, surfactants, and other additives. However, these efforts tend to introduce more problems than they solve, including toxicity concerns generated by inclusion of such additives into the materials. Such measures often require complex and expensive post-formation treatments to chemically and/or thermally remove such additives; and these treatments can degrade material properties of the resulting composites. As with functionalization and other treatments, such measures also often introduce defects into the particle structure that limit its beneficial properties and may tend to produce undesirable surface asperities or concentrations of defective particles in end products that detract from their usefulness.

Accordingly, there is a need for improved compositions for forming polyelectrolyte coatings.

### SUMMARY

In embodiments, an aqueous composition for forming a coating can include a cationic polyelectrolyte, an anionic polyelectrolyte; nanostructures; and, a crosslinking agent. The nanostructures can be present in an amount of about 0.025 wt % to 10 wt %, based on the total weight of the composition.

In embodiments, a composition for forming a coating can include a cationic polyelectrolyte, an anionic polyelectrolyte, nanostructures, a non-water solvent, and a crosslinking agent. The nanostructures can include unfunctionalized graphene nanoparticles.

In embodiments, a coating can include a crosslinked polyelectrolyte network including a cationic polyelectrolyte and an anionic polyelectrolyte, and nanostructures dispersed in the crosslinked polyelectrolyte network. The nanostructures can be present in an amount of about 1 wt % to about 50 wt %, based on the total weight of the coating. The coating can have a pencil hardness of at least about 10 H.

In embodiments, a method can include admixing an aqueous solution comprising a cationic polyelectrolyte, an aqueous solution comprising an anionic polyelectrolyte, and a crosslinking agent, thereby providing a coating solution. Each of the aqueous solution including the cationic polyelectrolyte and the aqueous solution including the anionic polyelectrolyte can include nanostructures dispersed therein. The aqueous solution including the cationic polyelectrolyte can have a pH of about 7.5 or less. The aqueous solution including the anionic polyelectrolyte can have a pH of less than about 2.

In embodiments, a method of coating a substrate can include applying a coating solution to a surface of a substrate, thereby providing a coated substrate. The coating solution can include an admixture of (a) an aqueous cationic polyelectrolyte solution including a cationic polyelectrolyte and nanostructures dispersed therein, (b) an aqueous anionic polyelectrolyte solution including an anionic polyelectrolyte and nanoparticles dispersed therein, and (c) a crosslinking agent. A curing solution can be applied to the coated substrate, thereby providing a curable coated substrate. The curable coated substrate can be dried, thereby crosslinking the cationic polyelectrolyte and the anionic polyelectrolyte to form a crosslinked polyelectrolyte network having nanoparticles dispersed therein on the surface of the substrate.

In embodiments, a kit for coating a substrate can include a coating solution. The coating solution can include an admixture of a cationic polyelectrolyte, an anionic polyelectrolyte, nanostructures, and a crosslinking agent. The kit can include a curing solution. The curing solution can include a volatile buffering agent. The kit can include instructions for applying the coating solution to a substrate and allowing the applied coating solution to dry before then applying the curing solution to cure the coating solution into a coating under ambient conditions.

Further aspects and advantages of the disclosure will be apparent to those of ordinary skill in the art from a review of the following detailed description. While the compositions and methods are susceptible of embodiments in various forms, the description hereafter includes specific embodiments, with the understanding that the disclosure is illustrative, and is not intended to limit the scope of the disclosure to the specific embodiments described herein.

### BRIEF DESCRIPTION OF THE DRAWINGS

FIG. 1 is an SEM image (scale=500 nm) of a coating prepared from a composition according to the disclosure comprising BPEI, PAA, and SWCNTs.

FIG. 2 is a graph of the ratio of areas under the 1700 cm⁻¹ and 1550 cm⁻¹ peaks from an FTIR spectrum, representing degree of ester formation normalized to initial carboxylate functionalities, as a function of cure time at 140° C.

FIG. 3 is a graph of the water uptake over time of a plastic bottle having no coating and a plastic bottle having a coating prepared from a composition according to the disclosure applied thereon.

FIG. 4A is a graph of the effect of pH and salt concentration on the phase of a PDDAC/PAA mixture containing 0.2 wt % SWCNTs.

FIG. 4B is a graph of the effect of pH and salt concentration on the phase of a PEI/PAA mixture containing 0.2 wt % SWCNTs.

### DETAILED DESCRIPTION

The disclosure generally relates to compositions for forming coatings and methods making and using the same. The compositions and methods of the disclosure can address problems associated with current polyelectrolyte compositions. For example, the compositions can provide coatings having an ionically and/or covalently crosslinked polyelectrolyte network comprising cationic and anionic polyelectrolyte chains with nanostructures finely or uniformly dispersed therein. The coatings prepared from the compositions of the disclosure can be solid, substantially homogeneous, and unitary in nature. Advantageously, coatings prepared in accordance with the disclosure can be monolayer coatings and can be applied on or adjacent to a surface, such as a metal, ceramic, glass, and other substrates or supports. The coatings of the disclosure can also be provided as self-supporting, mono- or multi-layer films which can be applied on or adjacent to a surface. In embodiments, the compositions of the disclosure can be mixed with or otherwise included with other polymeric or non-polymeric materials as one of several elements of a composite structure.

The compositions and coatings of the disclosure can exhibit substantial beneficial properties that include, for example, adherence to a variety of surface materials (e.g., metal, ceramic, plastic, and other substrates) and an enhanced combination of physical properties that include, but are not limited to, favorable tribological properties (e.g., in applications that require low friction and associated heat generation), high hardness, high impact resistance, suitable glass transition temperature, good flexibility, strength, flame resistance, antimicrobial and barrier properties (including moisture), and/or transparency. The coatings of the disclosure can be resistant to organic and inorganic solvents, such as toluene, acetone, DMF, DMSO, hexane, and the like.

### Compositions for Forming a Coating

Disclosed herein are compositions for forming a coating. The compositions can include a cationic polyelectrolyte, an anionic polyelectrolyte, nanostructures, and a crosslinking agent.

### Cationic Polyelectrolyte

The compositions of the disclosure can include a cationic polyelectrolyte. The cationic polyelectrolyte can be one or more of poly(diallyldimethyl ammonium) chloride (PDDAC), branched polyethyleneimine (BPEI), chitosan, polyvinyl alcohol (PVOH), poly(allylamine), polyvinylamine, polyvinyl formamide, a cationic polyamino acid, and a cationic protein. The cationic polyelectrolyte can generally include any linear or branched cationic homopolymer and copolymer that exhibits sufficient crosslinking with the anionic polyelectrolyte(s) under compatible conditions of pH and ionic strength. As used herein, the terms “sufficient crosslinking” mean that the cationic polyelectrolyte has a gel fraction of at least about 85%, 90%, 95%, 98%, or 99%. The gel fraction can be measured according to the methods known in the art. In embodiments, the cationic polyelectrolyte includes PDDAC. In embodiments, the cationic polyelectrolyte includes BPEI. In embodiments, the cationic polyelectrolyte includes PVOH. In embodiments, the cationic polyelectrolyte includes poly(allylamine). In embodiments, the cationic polyelectrolyte includes polyvinylamine. In embodiments, the cationic polyelectrolyte includes polyvinyl formamide. In embodiments, the cationic polyelectrolyte includes a cationic polyamino acid. In embodiments, the cationic polyelectrolyte includes a cationic protein.

The cationic polyelectrolyte can have a number-average molecular weight (Mₙ) or a weight-average molecular weight (M_{W}) of about 1 kDa to about 400 kDa, for example at least about 1, 2, 4, 5, 7, 10, 25, 50, 100, or 200 kDa and/or up to about 50, 75, 100, 125, 150, 200, 250, 300, 350, or 400 kDa. For example, the cationic polyelectrolyte can have a number-average molecular weight of about 1 kDa to about 350 kDa, about 2 kDa to about 300 kDa, about 10 kDa to about 200 kDa, about 25 kDa to about 150 kDa, about 50 kDa to about 100 kDa, or about 10 kDa to about 400 kDa. In embodiments, the cationic polyelectrolyte has a number-average molecular weight of about 10 kDa to about 200 kDa.

The cationic polyelectrolyte can be present in the composition in an amount of about 1 wt % to about 20 wt %, for example, at least about 1, 2, 3, 4, 5, 6, 7, 8, 9, 10, 11, or 12 wt % and/or up to about 8, 9, 10, 11, 12, 13, 14, 15, 16, 17, 18, 19, or 20 wt %, based on the total weight of the composition. For example, the cationic polyelectrolyte can be present in an amount of about 1 wt % to about 20 wt %, about 2 wt % to about 18 wt %, about 3 wt % to about 17 wt %, about 4 wt % to about 16 wt %, about 5 wt % to about 15 wt %, about 5 wt % to about 10 wt %, about 1 wt % to about 10 wt %, about 5 wt % to about 20 wt %, or about 8 wt % to about 12 wt %, based on the total weight of the composition. In embodiments, the cationic polyelectrolyte is present in an amount of about 1 wt % to about 20 wt %, based on the total weight of the composition. In embodiments, the cationic polyelectrolyte is present in an amount of about 1 wt % to about 10 wt %, based on the total weight of the composition.

### Anionic Polyelectrolyte

The compositions of the disclosure can include an anionic polyelectrolyte. The anionic polyelectrolyte can include one or more of polyacrylic acid (PAA), poly(styrene sulfonate) (PSS), a polyacid, polymethacrylic acid, polyethylene sulfonate, polypropylene sulfonate, an anionic polyamino acid, and an anionic protein. The anionic polyelectrolyte can include any linear or branched anionic polyelectrolyte that exhibits suitable crosslinking with the cationic polyelectrolyte(s) under compatible conditions of pH and ionic strength. In embodiments, the anionic polyelectrolyte includes PAA. In embodiments, the anionic polyelectrolyte includes PSS. In embodiments, the anionic polyelectrolyte includes a polyacid. In embodiments, the anionic polyelectrolyte includes polymethacrylic acid. In embodiments, the anionic polyelectrolyte includes polyethylene sulfonate. In embodiments, the anionic polyelectrolyte includes polypropylene sulfonate. In embodiments, the anionic polyelectrolyte includes an anionic polyamino acid. In embodiments, the anionic polyelectrolyte includes an anionic protein.

In embodiments, carboxylate functionalized polymers, such as poly(acrylic acid) PAA can be used as the anionic polyelectrolyte. By incorporating alcohol-containing moieties into the mixture, ester bonds can formed in the resulting crosslinked polyelectrolyte network. The resulting coatings, having these covalent ester bonds therein, can provide enhanced functional attributes, such as improved solvent resistance against both organic and aqueous-based solvents or media, especially brine, detergent, and other aqueous mixtures that heretofore could not be withstood by conventional polyelectrolyte coatings.

The anionic polyelectrolyte can have a number-average molecular weight (Mₙ) or a weight-average molecular weight (M_{W}) of about 1 kDa to about 400 kDa, for example at least about 1, 2, 4, 5, 7, 10, 25, 50, 100, or 200 kDa and/or up to about 50, 75, 100, 125, 150, 200, 250, 300, 350, or 400 kDa. For example, the anionic polyelectrolyte can have a number-average molecular weight of about 1 kDa to about 350 kDa, about 2 kDa to about 300 kDa, about 10 kDa to about 200 kDa, about 25 kDa to about 150 kDa, about 50 kDa to about 100 kDa, or about 10 kDa to about 400 kDa. In embodiments, the anionic polyelectrolyte has a number-average molecular weight of about 10 kDa to about 200 kDa.

The anionic polyelectrolyte can be present in the composition in an amount of about 1 wt % to about 20 wt %, for example, at least about 1, 2, 3, 4, 5, 6, 7, 8, 9, 10, 11, or 12 wt % and/or up to about 8, 9, 10, 11, 12, 13, 14, 15, 16, 17, 18, 19, or 20 wt %, based on the total weight of the composition. For example, the anionic polyelectrolyte can be present in an amount of about 1 wt % to about 20 wt %, about 2 wt % to about 18 wt %, about 3 wt % to about 17 wt %, about 4 wt % to about 16 wt %, about 5 wt % to about 15 wt %, about 5 wt % to about 10 wt %, about 1 wt % to about 10 wt %, about 5 wt % to about 20 wt %, or about 8 wt % to about 12 wt %, based on the total weight of the composition. In embodiments, the anionic polyelectrolyte is present in an amount of about 1 wt % to about 20 wt %, based on the total weight of the composition. In embodiments, the anionic polyelectrolyte is present in an amount of about 1 wt % to about 10 wt %, based on the total weight of the composition.

The cationic polyelectrolyte and the anionic polyelectrolyte can be present in a weight ratio of about 1:4 to about 4:1. For example, the cationic polyelectrolyte and the anionic polyelectrolyte can be present in a ratio of at least about 1:4, 1:3.5, 1:3, 1:2.5, 1:2, 1:1.5 or 1:1, and/or up to about 4:1, 3.5:1, 3:1, 2.5:1, 2:1, 1.5:1, or 1:1, such as about 1:4 to about 4:1, about 1:3 to about 3:1, about 1:2 to about 2:1, or about 1:1. In embodiments, the cationic polyelectrolyte and anionic polyelectrolyte are present in a weight ratio of about 1:4. In embodiments, the cationic polyelectrolyte and anionic polyelectrolyte are present in a weight ratio of about 1:3. In embodiments, the cationic polyelectrolyte and anionic polyelectrolyte are present in a weight ratio of about 1:2. In embodiments, the cationic polyelectrolyte and anionic polyelectrolyte are present in a weight ratio of about 1:1. In embodiments, the cationic polyelectrolyte and anionic polyelectrolyte are present in a weight ratio of about 2:1. In embodiments, the cationic polyelectrolyte and anionic polyelectrolyte are present in a weight ratio of about 3:1. In embodiments, the cationic polyelectrolyte and anionic polyelectrolyte are present in a weight ratio of about 4:1.

### Nanostructures

The compositions of the disclosure can include nanostructures. Advantageously, the compositions and coatings of the disclosure can include relatively high loading levels of finely dispersed nanostructures due to the dispersive nature of the anionic and cationic polyelectrolytes. As used herein, the term “finely dispersed” means that the nanostructures are dispersed within the compositions and/or coatings of the disclosure such that they do not form optically visible agglomerates or precipitates that cannot be readily removed (e.g., through decanting or simple filtration). That is, the polyelectrolytes can act as dispersants in addition to providing the crosslinked polyelectrolyte network of the coating. Significantly, the coatings can provide a fine dispersion of the nanostructures, which had previously been difficult to obtain, absent the inclusion of any additional dispersants, due to the agglomeration of the nanostructures when included in high levels. Accordingly, the compositions can be free of an added dispersant. As used herein, the phrase “free of an added dispersant” means that the composition can suitably include less than about 5, 4, 3, 2, 1, 0.5, 0.1, or 0.01 wt % of a dispersant that was intentionally added to the composition. In embodiments, the compositions include less than 0.01 wt % of an added dispersant.

In general, the nanostructures of the disclosure can have minimal or no effective ionic charge. The nanostructures can be unfunctionalized. As used herein, the term “unfunctionalized” or “unfunctionalized nanostructures” refers to nanostructures that are free of oxidative or reductive functionality that can, for example, allow dispersion. Furthermore, unfunctionalized nanostructures are generally incapable of directly interacting with the cationic polyelectrolyte, the anionic polyelectrolyte, or any polyelectrolyte formed therefrom through the formation of ionic bonds. Unfunctionalized nanostructures may also be referred to as “pristine.” Examples of functionalized nanostructures, which are not suitable for use in the compositions of the disclosure include, for example, graphene oxide, ionic nanoclays (e.g., montmorillonite clay, laponite clay), colloidal silica, and charged polymer latexes. In embodiments, the compositions are free of functionalized nanostructures. As used herein, “free of functionalized nanostructures,” means that the compositions suitably contain less than about 1, 0.5, 0.05, 0.01, 0.001 wt % of functionalized nanostructures (e.g., graphene oxide nanoparticles), based on the total weight of the composition. Similarly, unfunctionalized graphene nanoparticles refer to graphene nanoparticles having a carbon content of at least about 99.0 wt % or at least about 99.5 wt %, based on the total weight of the nanoparticles.

Although chemical functionalization of nanostructures by oxidation, reduction of oxidized forms, and other treatments can enhance the dispersibility of the nanostructures in aqueous media and limit their tendency to form aggregates, this functionalization introduces defects in the nanostructures that can diminish their beneficial properties. Unfortunately, the dispersibility of functional derivatives of graphenic and other nanostructures in general is almost inversely proportional to their beneficial physical properties. For example, the aqueous dispersibility of graphenic nanoparticles is believed to generally follow the general trend graphene oxide (GO)>reduced graphene oxide (rGO)>unfunctionalized graphene (G), while beneficial mechanical and other properties resulting from inclusion of the various forms of such particles tend to generally follow a reverse order. Advantageously, and surprisingly, it was observed that the polyelectrolytes themselves can function as dispersants, allowing unfunctionalized graphene (G) to be used to prepare the coatings as described herein. Accordingly, the compositions of the disclosure can provide coatings that can achieve the superior mechanical and physical properties of unfunctionalized graphene, while maintaining a fine dispersion of nanoparticles, previously only achievable with functionalized graphene (e.g., GO or rGO). The term “graphene” is often used in the art to generally refer to graphene without regard to whether it is in a functionalized or unfunctionalized form. Conventional coating technologies using graphene and generally referring to compositions having graphene would be understood in the art to contain functionalized graphenes, as such conventional coatings required the functionalization for dispersibility. In embodiments herein, the graphene in the compositions of the disclosure is unfunctionalized and will be referred to herein a unfunctionalized graphene for clear distinction from functionalized graphene.

The nanostructures can include one or more of unfunctionalized graphene nanoparticles, single-wall carbon nanotubes (SWCNTs), multi-wall carbon nanotubes (MWCNTs), silver nanowires, and hexagonal boron nitride. In embodiments, the nanostructures include unfunctionalized graphene nanoparticles. In embodiments, the nanostructures include unfunctionalized graphene nanoparticles, wherein at least 50% of the unfunctionalized graphene nanoparticles have 10 layers or less, for example 9 layers or less, 8 layers or less, 7 layers or less, 6 layers or less, 5 layers or less, 4 layers or less, 3 layers or less, 2 layers or less, or 1 layer. In embodiments, the nanostructures include SWCNTs. In embodiments, the nanostructures include MWCNTs. In embodiments, the nanostructures include silver nanowires. In embodiments, the nanostructures include hexagonal boron nitride.

The nanostructures can have an average diameter or effective diameter of about 1 nm to about 100,000 nm (100 μm), for example at least about 1, 2, 3, 4, 5, 10, 15, 20, 25, 30, 40, 50, 100, 200, 300, 400, 500, 750, 1000, 2000, 3000, 5000, 10,000, or 50,000 nm, and/or up to about 100,000, 75,000, 50,000, 25,000 10,000, 7500, 5000, 2500, 1000, 750, 500, 100, 90, 75, 60, or 50 nm. For example, the nanostructures can have an average diameter of about 1 nm to 100 μm, about 1 nm to about 10 μm, about 1 nm to about 1 μm, about 1 nm to about 500 nm, about 1 nm to about 100 nm, about 5 nm to about 95 nm, about 10 nm to about 90 nm, about 15 nm to about 85 nm, about 20 nm to about 80 nm, about 25 nm to about 75 nm, about 40 nm to about 50 nm, about 50 nm to about 5 μm, about 50 nm to about 100 μm, or about 5 μm to about 100 μm.

The nanostructures can be present in an amount of about 0.025 wt % to about 10 wt %, for example, at least about 0.025, 0.03, 0.04, 0.05, 0.075, 0.1, 0.5, 0.75, 1, 2, 3, 4, 5, or 6 wt % and/or up to about 0.5, 1, 2, 3, 4, 5, 6, 7, 8, 9, or 10 wt %, based on the total weight of the composition. For example, the nanostructures can be present in an amount of about 0.025 wt % to about 10 wt %, about 0.025 wt % to about 9 wt %, about 0.025 wt % to about 8 wt %, about 0.025 wt % to about 7 wt %, about 0.025 wt % to about 5 wt %, about 0.05 wt % to about 10 wt %, about 0.05 wt % to about 7 wt %, about 0.05 wt % to about 5 wt %, about 0.5 wt % to about 10 wt %, about 0.5 wt % to about 7 wt %, about 0.5 wt % to about 5 wt %, about 0.5 wt % to about 1 wt %, about 1 wt % to about 10 wt %, about 2 wt % to about 9 wt %, about 3 wt % to about 8 wt %, or about 4 wt % to about 7 wt %, based on the total weight of the composition. In embodiments, the nanostructures are present in an amount of about 0.025 wt % to about 10 wt %, based on the total weight of the composition. In embodiments, the nanostructures are present in an amount of about 0.025 wt % to about 7 wt %, based on the total weight of the composition. In embodiments, the nanostructures are present in an amount of about 0.3 wt %, based on the total weight of the composition. In embodiments, the nanostructures are present in an amount of about 1 wt %, based on the total weight of the composition.

### Crosslinking Agent

The compositions of the disclosure can include a crosslinking agent. The crosslinking agent can be used to facilitate the crosslinking of the cationic polyelectrolyte and the anionic polyelectrolyte to provide a crosslinked polyelectrolyte network.

The crosslinking agent can include one or more of 1,3-propanediol, ethylene glycol, glycerol, tris(hydroxymethyl)propane, polyethyleneimine (PEI), and polyvinyl alcohol (PVOH). In embodiments, the crosslinking agent includes 1,3-propanediol. In embodiments, the crosslinking agent includes ethylene glycol. In embodiments, the crosslinking agent includes glycerol. In embodiments, the crosslinking agent includes tris(hydroxymethyl)propane. In embodiments, the crosslinking agent includes PEI, such as branched PEI (BPEI). In embodiments, the crosslinking agent includes PVOH. In embodiments, the crosslinking agent includes glycerol and BPEI.

The crosslinking agent can be included in an amount of about 0.1 wt % to about 20 wt %, for example, at least about 0.1, 0.5, 1, 2, 3, 4, 5, 6, 7, 8, 9, or 10 wt % and/or up to about 8, 9, 10, 11, 12, 13, 14, 15, 16, 17, 18, 19, or 20 wt %, based on the total weight of the composition. For example, the crosslinking agent can be present in an amount of about 0.1 wt % to about 20 wt %, about 0.5 wt % to about 18 wt %, about 1 wt % to about 17 wt %, about 2 wt % to about 16 wt %, about 4 wt % to about 15 wt %, about 5 wt % to about 10 wt %, about 1 wt % to about 10 wt %, about 5 wt % to about 20 wt %, or about 8 wt % to about 12 wt %, based on the total weight of the composition. In embodiments, the crosslinking agent is present in an amount of about 1 wt % to about 20 wt %, based on the total weight of the composition. In embodiments, the crosslinking agent is present in an amount of about 1 wt % to about 10 wt %, based on the total weight of the composition.

In embodiments, the cationic polyelectrolyte includes poly(diallyldimethyl ammonium) chloride (PDDAC), the anionic polyelectrolyte includes polyacrylic acid (PAA), the nanostructures comprise graphene nanoplatelets or single-wall carbon nanotubes (SWCNTs), and the crosslinking agent comprises branched polyethyleneimine (BPEI).

### Solvent

The compositions of the disclosure can include a solvent. The solvent can be a protic solvent. The solvent includes water. In embodiments, the solvent further includes a non-water solvent. The non-water solvent should be polar and fully miscible with water. Examples of suitable non-water solvents include ammonia, acetic acid, ethanol, acetone, methanol, and isopropanol. In embodiments, the solvent includes a non-water solvent. For example, in embodiments, the solvent includes water and ethanol. In embodiments, the solvent includes water and acetone. In embodiments, the solvent includes water and methanol. In embodiments, the solvent includes water and isopropanol. When the solvent includes a mixture of water and a non-water solvent, the water and the non-water solvent can be present in a ratio of about 3:1 to about 1:3, for example about 3:1, about 2:1, about 1:1, about 1:2, or about 1:3.

The solvent can be present in an amount of about 10 wt % to about 98 wt %, for example at least about 10, 20, 30, 40, 50, 60, 70 wt % and/or up to about 60, 70, 80, 90, 95, 97, 97.5 or 98 wt %, based on the total weight of the composition.

The compositions can have a pH of about 2 to about 9, for example at least about 2, 3, 4, 5, or 6 and/or up to about 4, 5, 6, 7, 8, or 9. For example, the compositions can have a pH of about 2 to about 9, about 2 to about 8, about 2 to about 7, about 3 to about 9, about 4 to about 8, about 4 to about 7, or about 5 to about 6. In embodiments, the composition has a pH of about 4 to about 7.

### Coatings

The disclosure further provides coatings prepared from the compositions of the disclosure. In embodiments, the coating is an antimicrobial coating.

The coating can include a crosslinked polyelectrolyte network. The crosslinked polyelectrolyte network is formed by crosslinking of one or more cationic polyelectrolytes present in the composition with the one or more anionic polyelectrolytes present in the composition. The crosslinked polyelectrolyte network can further include the crosslinking agent, for example where one or more of the cationic polyelectrolytes or anionic polyelectrolytes was also the crosslinking agent. For example, in embodiments a BPEI cationic polyelectrolyte can also be provided as the crosslinking agent.

The anionic polyelectrolyte and the cationic polyelectrolyte can be crosslinked via covalent bonds to form the crosslinked polyelectrolyte network in accordance with embodiments of the disclosure. The covalent bonds can be formed due to the presence of hydroxyl and/or primary amine functional groups on the anionic and/or cationic polyelectrolytes. In embodiments, the cationic polyelectrolyte and the anionic polyelectrolyte are crosslinked via ester bonds, amide bonds, or both to form the crosslinked polyelectrolyte network. In embodiments, the cationic polyelectrolyte and the anionic polyelectrolyte are crosslinked via ester bonds. In embodiments, the cationic polyelectrolyte and the anionic polyelectrolyte are crosslinked via amide bonds. In embodiments, cationic polyelectrolyte and the anionic polyelectrolyte are crosslinked via ester bonds and amide bonds.

The anionic polyelectrolyte and the cationic polyelectrolyte can be crosslinked via ionic bonds to form the crosslinked polyelectrolyte network in accordance with embodiments of the disclosure. In such embodiments, the crosslinked polyelectrolyte network is free of covalent crosslinking. For example, in embodiments, the crosslinked polyelectrolyte network is formed completely from ionic crosslinking and any electrostatic interactions generally attributable to the charges of the polyelectrolytes.

The coatings of the disclosure include the nanostructures, as described herein. The nanostructures can be finely dispersed throughout the crosslinked polyelectrolyte network. The nanostructures can be present in the coating in an amount of 1 wt % to about 50 wt % for example, at least about 1, 2, 3, 4, 5, 7, 10, 15, 20, 25, or 30 wt % and/or up to about 10, 12, 15, 17, 20, 25, 30, 33, 45, or 50 wt %, based on the total weight of the coating. For example, the nanostructures can be provided in the coating, after evaporation or other removal of the solvent and impurities, in an amount of about 1 wt % to about 50 wt %, about 1 wt % to about 40 wt %, about 1 wt % to about 33 wt %, about 1 wt % to about 30 wt %, about 1 wt % to about 20 wt %, about 2 wt % to about 18 wt %, about 4 wt % to about 16 wt %, about 5 wt % to about 15 wt %, or about 10 wt % to about 50 wt %, based on the total weight of the coating. In embodiments, the nanostructures are present in an amount of at least about 10 wt %, based on the total weight of the coating. In embodiments, the nanostructures are present in an amount about 1 wt % to about 10 wt %, based on the total weight of the coating, such as about 1, 2, 3, 4, 4.5, 5, 6, 7, 8, 9, or 10 wt %.

The coatings of the disclosure can have a thickness of about 0.2 μm to about 50 μm, for example at least about 0.2, 0.3, 0.4, 0.5, 1, 2, 3, 4, 5, 7, 10, 15, 20, 25, or 30 μm and/or up to about 20, 25, 30, 35, 40, 45, or 50 μm. For example, the coatings can have a thickness of about 0.2 μm to about 50 μm, about 0.8 μm to about 45 μm, about 1 μm to about 40 μm, about 2 μm to about 30 μm, about 3 μm to about 25 μm, about 5 μm to about 25 μm, about 20 μm to about 15 μm, or about 1 μm to about 5 μm. In embodiments, the coating has a thickness of about 0.5 μm. In embodiments, the coating has a thickness of about 1 μm to about 5 μm. In embodiments, the coating has a thickness of about 1 μm. In embodiments, the coating has a thickness of about 5 μm. In embodiments, the coating has a thickness of about 25 μm.

The coatings of the disclosure can have a Mohs hardness of at least about 1, for example about 1, about 2, about 3, about 4, or about 5. In embodiments, the coating has a Mohs hardness of about 4 to about 5. Mohs hardness can be determined in accordance with methods generally known in the art, for example, using a Mohs hardness kit for aluminum. Alternatively or additionally, the coatings of the disclosure can have a pencil hardness of at least 6 H, at least 7 H, at least 8 H, at least 9 H, or 10 H. In embodiments, the coatings of the disclosure can have a pencil hardness of 6 H to 10 H, 7 H to 10 H, 8 H to 10 H, or 9 H to 10 H. In embodiments, the coatings exhibit a 10 H hardness. When the coating is applied to a softer surface (e.g., a fabric or a nonwoven substrate such as a mask), the coatings may have a hardness of at least 2 H, 3 H, 4 H, 5 H, or 6 H. The pencil hardness of the coating can be determined by a pencil hardness test (ASTM D3363). Advantageously, embodiments of the coatings of the disclosure can have a higher pencil hardness than conventional epoxy coatings (e.g., 7 H or 8 H) or powder coatings (e.g., 6 H). In embodiments, the coatings of the disclosure can have a hardness comparable to formaldehyde-based coatings (e.g., 9 H or 10 H), but beneficially avoid the toxicity concerns associated with formaldehyde-based coatings.

The coatings of the disclosure can have a glass transition temperature of at least about 145° C. The glass transition temperature can be determined by the tan(delta) peak in dynamic mechanical analysis (DMA), on heating, at a 2° C./min ramp, where the material is in tension mode, 0.1% strain, at 1 Hz frequency. In embodiments, the glass transition temperature is at least about 145, 150, 155, 160, 175, 200, 220, 225, 230, 240, 250, 275, or 300° C. and/or up to about 400, 350, 300, 290, 280, 270, 260, 250, 220, 200, or 150° C. In embodiments, the coating has a glass transition temperature of at least 150° C. In embodiments, the coating has a glass transition temperature of at least 200° C. In embodiments, the coating has a glass transition temperature of about 150° C. to about 220° C.

The coatings of the disclosure can have a friction coefficient of less than about 0.1, for example less than about 0.1, 0.09, 0.08, 0.07, 0.06, or 0.05. In embodiments, the coating has a friction coefficient of less than about 0.08. In embodiments, the coating has a friction coefficient of less than about 0.07.

The coating of the disclosure can be provided on or adjacent to a surface of a substrate. The coating of the disclosure can be provided as a self-supporting film. For example, the compositions can be castable, moldable, or otherwise amenable to formation as free-standing, substantially self-supporting films, sheets, coatings, or other configurations. In embodiments, the self-supporting film can be provided on or adjacent a surface of a substrate.

The compositions of the disclosure can be applied as a coating on a number of substrates. Examples of materials that can provide suitable substrates include, but are not limited to, aluminum, 304 stainless steel, 316 stainless steel, brass, glass, quartz, polyester (e.g., polyurethane, polyethylene terephthalate, etc.), polypropylene, acrylonitrile-butadiene-styrene (ABS), polycarbonate, polyurethane, porcelain, fabrics (e.g., cotton), nitrile rubber, carbon steel, high density polyethylene (HDPE), wood (e.g., plywood, medium-density fiberboard), and polyurethane foam.

### Methods

The disclosure further provides methods of preparing and using the compositions and coatings of the disclosure.

The methods can include admixing an aqueous solution including a cationic polyelectrolyte, an aqueous solution including an anionic polyelectrolyte, and a crosslinking agent to provide a coating solution. Each of the cationic polyelectrolyte, the anionic polyelectrolyte, and the crosslinking agent can be as described herein.

The cationic polyelectrolyte can be present in the aqueous solution including the cationic polyelectrolyte (i.e., the “cationic polyelectrolyte solution”) in an amount of about 2 wt % to about 20 wt %, based on the total weight of the cationic polyelectrolyte solution, for example about 2 wt % to about 20 wt %, about 2 wt % to about 15 wt %, about 6 wt % to about 10 wt %, about 2, 3, 4, 5, 6, 7, 8,9, 10, 11, 12, 13, 14, 15, 16, 17, 18, 19, or 20 wt %, based on the total weight of the cationic polyelectrolyte solution. In embodiments, the cationic polyelectrolyte solution includes about 6 wt % cationic polyelectrolyte. In embodiments, the cationic polyelectrolyte solution includes about 8 wt % cationic polyelectrolyte. In embodiments, the cationic polyelectrolyte solution includes about 10 wt % cationic polyelectrolyte.

The anionic polyelectrolyte can be present in the aqueous solution including the anionic polyelectrolyte (i.e., the “anionic polyelectrolyte solution”) in an amount of about 2 wt % to about 20 wt %, based on the total weight of the anionic polyelectrolyte solution, for example about 2 wt % to about 20 wt %, about 2 wt % to about 15 wt %, about 6 wt % to about 10 wt %, about 2, 3, 4, 5, 6, 7, 8,9, 10, 11, 12, 13, 14, 15, 16, 17, 18, 19, or 20 wt %, based on the total weight of the anionic polyelectrolyte solution. In embodiments, the anionic polyelectrolyte solution includes about 6 wt % anionic polyelectrolyte. In embodiments, the anionic polyelectrolyte solution includes about 8 wt % anionic polyelectrolyte. In embodiments, the anionic polyelectrolyte solution includes about 10 wt % anionic polyelectrolyte.

One or both of the cationic polyelectrolyte solution and the anionic polyelectrolyte solution can additionally include nanostructures. Alternatively, the nanostructures can be added after admixing the cationic and anionic polyelectrolyte solutions. In embodiments, the cationic polyelectrolyte solution includes nanostructures. In embodiments, the anionic polyelectrolyte solution includes nanostructures. In embodiments, each of the cationic polyelectrolyte solution and the anionic polyelectrolyte solution include nanostructures. In embodiments, the nanostructures are separately added to the coating solution, after the anionic polyelectrolyte solution and the cationic polyelectrolyte solution are combined. The nanostructures can be present in the cationic polyelectrolyte solution, the anionic polyelectrolyte solution, and/or the coating solution in an amount of about 0.025 wt % to about 10 wt %, for example, at least about 0.025, 0.03, 0.04, 0.05, 0.075, 0.1, 0.5, 0.75, 1, 2, 3, 4, 5, or 6 wt % and/or up to about 0.5, 1, 2, 3, 4, 5, 6, 7, 8, 9, or 10 wt %, based on the total weight of the cationic and/or anionic polyelectrolyte solution. For example, the nanostructures can be present in an amount of about 0.025 wt % to about 10 wt %, about 0.025 wt % to about 9 wt %, about 0.025 wt % to about 8 wt %, about 0.025 wt % to about 7 wt %, about 0.025 wt % to about 5 wt %, about 0.05 wt % to about 10 wt %, about 0.05 wt % to about 7 wt %, about 0.05 wt % to about 5 wt %, about 0.5 wt % to about 10 wt %, about 0.5 wt % to about 7 wt %, about 0.5 wt % to about 5 wt %, about 0.5 wt % to about 1 wt %, about 1 wt % to about 10 wt %, about 2 wt % to about 9 wt %, about 3 wt % to about 8 wt %, or about 4 wt % to about 7 wt %, based on the total weight of the cationic and/or anionic polyelectrolyte solution. In embodiments, the nanostructures are present in an amount of about 0.025 wt % to about 10 wt %, based on the total weight of the cationic and/or anionic polyelectrolyte solution. In embodiments, the nanostructures are present in an amount of about 0.025 wt % to about 7 wt %, based on the total weight of the cationic and/or anionic polyelectrolyte solution. In embodiments, the nanostructures are present in an amount of about 0.3 wt %, based on the total weight of the cationic and/or anionic polyelectrolyte solution. In embodiments, the nanostructures are present in an amount of about 1 wt %, based on the total weight of the cationic and/or anionic polyelectrolyte solution.

The cationic polyelectrolyte solution can have a pH of about 8 or less, for example about 8, about 7.8, about 7.5, about 7, about 6.5, about 6, about 5.5, about 5, about 4.5, about 4, about 3.5, about 3, about 2.5, about 2, or about 1.5. In embodiments, the cationic polyelectrolyte solution has a pH of about 7.5 or less. In embodiments, the cationic polyelectrolyte solution has a pH of about 6.5 or less.

The anionic polyelectrolyte solution can have a pH of about 8 or less, for example about 8, about 7.8, about 7.5, about 7, about 6.5, about 6, about 5.5, about 5, about 4.5, about 4, about 3.5, about 3, about 2.5, about 2, or about 1.5. In embodiments, the anionic polyelectrolyte solution has a pH of about 8. In embodiments, the anionic polyelectrolyte solution has a pH of about 6.5. In embodiments, the anionic polyelectrolyte solution can have a pH of about 2.5 or less, for example about 2.5, about 2.4, about 2.2, about 2, about 1.8, about 1.5, about 1.2, or about 1. In embodiments, the anionic polyelectrolyte solution has a pH of about 1.5 to about 1.8. In embodiments, the anionic polyelectrolyte solution has a pH of about 2.4. In embodiments, the anionic polyelectrolyte solution has a pH of about 2.2.

In embodiments, the coating solution, prepared by admixing the cationic polyelectrolyte solution and the anionic polyelectrolyte solution, can have a pH of about 1.5 to about 8, for example at least about 1.5, 2, 2.5, 3. 3.5, 4, 4.5, or 5 and/or up to about 4, 4.5, 5, 5.5, 6, 6.5, 7, 7.5, or 8. In embodiments, the coating solution has a pH of about 1.5 to about 7.5. In embodiments, the coating solution has a pH of about 2.2. In embodiments, the coating solution has a pH about 8.

The pH of each of the cationic polyelectrolyte solution, the anionic polyelectrolyte solution, and the coating solution should be controlled, depending on the particular polyelectrolyte(s), to ensure that the polyelectrolytes are properly charged in solution to allow for electrostatic, ionic, and/or covalent crosslinking. Additionally, proper control of the pH can reduce or eliminate precipitation from the polyelectrolyte(s) and/or the nanostructures from the solution.

Each of the anionic polyelectrolyte solution, the cationic polyelectrolyte solution, and the coating solution include water as a solvent. In embodiments, the coating solution further includes a non-water solvent. The non-water solvent should be polar and fully miscible with water. Examples of suitable non-water solvents include ethanol, methanol, acetone, and isopropanol. In embodiments, the coating solution includes ethanol. In embodiments, the coating solution includes methanol. In embodiments, the coating solution includes acetone. In embodiments, the coating solution includes isopropanol. The non-water solvent can be provided in the coating solution as a component of the cationic polyelectrolyte solution or the anionic polyelectrolyte solution. Alternatively, or additionally, the non-water solvent can be separately added to the coating solution (containing the admixture of the anionic polyelectrolyte solution and the cationic polyelectrolyte solution).

The coating solution can be prepared by admixing the cationic polyelectrolyte solution and the anionic polyelectrolyte solution in a weight ratio of about 1:4 to about 4:1, as described herein for the compositions of the disclosure. For example, in embodiments, the coating solution is prepared by admixing 57 wt. % of the anionic polyelectrolyte solution and 43 wt. % of the cationic polyelectrolyte solution.

The coating solution can further include a crosslinking agent. The crosslinking can be as described herein for the compositions of the disclosure. In embodiments, the crosslinking agent includes glycerol, branched polyethyleneimine (BPEI), or both. The coating solution can include a crosslinking agent in an amount of about 0.1 wt % to about 20 wt %, for example, at least about 0.1, 0.5, 1, 2, 3, 4, 5, 6, 7, 8, 9, or 10 wt % and/or up to about 8, 9, 10, 11, 12, 13, 14, 15, 16, 17, 18, 19, or 20 wt %, based on the total weight of the coating.

The methods can include depositing the coating solution on or adjacent to a surface of a substrate to provide a coated substrate. Coating solutions of the disclosure can beneficially adhere to a variety of surfaces as descried in detail above. The coating solution can be deposited, for example, by dipping, spraying, brushing, wiping, or any other method known or used in the art. After application, the coating solution can be dried, for example, at ambient conditions, or in an oven.

The methods can include applying a curing solution on or adjacent the coated substrate to provide a curable coated substrate. The curing solution can include a buffering agent. Examples of suitable buffering agents include, but are not limited to, phosphate and citrate. In embodiments, the buffering agent comprises a volatile buffering agent, such as ammonium acetate. Advantageously, use of a volatile buffering agent like ammonium acetate can facilitate ionic crosslinking and readily evaporate from the coating such that a heating step is not needed to provide the final cured coating. In embodiments, the buffering agent includes one or more of phosphate, citrate, and ammonium acetate. In embodiments wherein the curing solution comprises ammonium acetate, the curing solution can have a pH of about 3 to about 7.5, for example about 3 to about 7, about 3 to about 6, about 3 to about 5, about 3 to about 4, about 6.5 to about 7.5, about 7 to about 7.5, about 3.5 to about 4.5, about 3.9 to about 4, about 3, about 3.5, about 3.9, about 4, about 4.5, about 5, about 6, about 7, or about 7.5.

The curing solution can be deposited on the coated substrate, for example, by dipping, spraying, brushing, wiping, or any other method known or used in the art. After application of the curing solution, the curable coated substrate can be dried, for example, under ambient conditions or by heating in an oven. While drying under ambient conditions can provide ionically crosslinked polyelectrolyte network, drying by heating in the oven can provide an ionically and covalently crosslinked polyelectrolyte network.

Upon application of the curing solution onto the coated substrate, the curable coated substrate can be heated at a temperature above about 100° C. Heating can induce and drive the esterification reaction to completion as water is removed, causing formation of ester linkages and covalent bonds in the crosslinked polyelectrolyte network along with ionic crosslinking. In embodiments, the coating can be cured at a pH of about 3 to about 4, e.g., about 3, 3.5, or 4, which is acidic enough to facilitate catalysis of the esterification reaction. The methods can include heating the curable coated substrate to a temperature of at least about 100° C., for example about 100, 110, 120, 130, 140, 150, 160, 170, 180, 190, or 200° C. In embodiments, the curable coated substrate is heated to a temperature of about 150° C. The curable coated substrate can be heated at a temperature of at least about 100° C. for about 1 minute to about 60 minutes, about 1 minute to about 45 minutes, about 2 minutes to about 30 minutes, about 3 minutes to about 15 minutes, about 1 minute, about 2 minutes, about 3 minutes, about 5 minutes, about 10 minutes, about 15 minutes, about 20 minutes, about 30 minutes, about 45 minutes, or about 60 minutes, in order to induce covalent crosslinking of the polyelectrolytes and to remove any excess solvent or impurities. In embodiments, the curable coated substrate is heated for about 2 minutes. In embodiments, the curable coated substrate is heated for about 3 minutes. In embodiments, the curable coated substrate is heated for about 5 minutes.

The compositions of the disclosure can be used to provide coatings that do not require a heating or “baking” step. In such embodiments, the coating solutions of the disclosure can be applied to a substrate, and dried under ambient conditions. Any suitable application methods can be used depending on the substrate to be coated. For example, the coating solution can be provided as a sprayable composition. In such embodiments, the nanostructures can include unfunctionalized graphene. Once the coating solution is dried, the curing solution can be applied. In such embodiments, the curing solution includes a volatile buffering agent. For example, in such embodiments, the curing solution includes an ammonium acetate buffering agent. The curing solution can have a pH of about 3.5 to about 4, for example about 3.9 to about 4, or it can have a pH of about 6.5 to 7.5, for example about 7 to about 7.5. Application of the curing solution containing the volatile buffering agent can induce ionic crosslinking of the anionic and cationic polyelectrolytes in the coating. Moreover, due to the volatility of the curing solution, the coating does not need to be heated to quickly dry the coating. Rather, the volatility of the curing solution facilitates quick drying of the coating under ambient conditions. The resulting coatings can be robust while additionally imparting bacteriostatic and bactericidal properties to the substrate. For example, the nanostructures can be present in the final coating in amounts of about 1 wt % to about 10 wt %, such as about 5 wt %. Such embodiments are particularly useful in providing coatings on high contact surfaces (e.g., door knobs, hand rails, etc.) that are cannot feasibly be heated or dried under heat in an oven.

The compositions of the disclosure can be used to provide a coating having an increased loading of nanostructures, as compared to comparative films generally known in the art. In such embodiments, the nanostructures can be present in the coatings in an amount of at least 10 wt %, for example at least about 10, 15, 20, 25, 30, 33, or 35 wt % and/or up to about 30, 33, 35, 40, 45, or 50 wt %, based on the total weight of the coating. Each of the anionic polyelectrolyte and the cationic polyelectrolyte can be provided in amounts generally described herein. In such embodiments, the coating solution can be applied to a substrate and allowed to dry. Alternatively, or additionally, the coating solution can be heated to increase the drying rate. Once the coating solution is dry, a curing solution can be applied. The curing solution can include a buffering agent, such as a phosphate or citrate buffer. Application of the curing solution can induce ionic crosslinking of the anionic and cationic polyelectrolytes in the coating. After application of the curing solution, the substrate can be heated or “baked” at a temperature of at least about 100° C. to induce covalent crosslinking of the anionic and polyelectrolytes in the coating. The final coating can have robust and increased physical and mechanical properties, such as scratch resistance, electric conductivity, and the like, due to the increased loading of the nanostructures, as well as the presence of both ionic and covalent crosslinking within the crosslinked polyelectrolyte network. These coatings can also have the antimicrobial properties as described herein.

### Kits for Coating Substrates

In accordance with embodiments, a kit for coating a substrate can include any one or more of the solutions described herein, packaged either separately (e.g., in separate bottles or containers) or together (e.g., admixed together in a single bottle or container) within the kit.

For example, kits for coating a substrate can include the coating solution and the curing solution. The coating solution and the curing solution can be packaged in separate bottles (e.g., spray bottles) within the kit. The kit can further include instructions for use. The instructions can describe the application of the coating solution and the curing solution in order to provide a coating, for example an antimicrobial coating, on a surface. In embodiments, the kit includes instructions to apply the coating solution to the desired substrate, allow the coated substrate to dry, and then to apply the curing solution to the dried coated substrate. Kits that include the coating solution and the curing solution can be useful to coat surfaces such as handrails, door knobs, surgical tools, hospital equipment (carts, handles, and the like), and other areas of high contact that are incapable of being heated, for example, in an oven to induce covalent crosslinking. In embodiments, the curing solution within the kit includes a volatile buffering agent, such as ammonium acetate, as described herein. The ammonium acetate can have a pH of about 3 to about 7.5, for example about 3.9 to about 4, or about 7 to about 7.5, the latter of which is particularly suitable for biomedical and hospital settings.

### Applications of the Coatings

The coatings of the disclosure can be used as gas/vapor barriers, lubrication layers, flame retardants, antimicrobial coatings, scratch-resistant coatings, electrically conductive coatings, oleophilic coatings, corrosion or chemical resistant coatings, and the like.

In embodiments, the coatings described herein are used as a gas/vapor barrier. The coatings of the disclosure reveal the strong synergy between nanostructures and polyelectrolytes in the coating. Certain polyelectrolyte films known in the art are said to possess excellent oxygen barrier properties; however, they tend to fail in high humidity environments and fail to stop very small gas molecules, such as helium or hydrogen. In embodiments, the coating provides a superior barrier against diffusion of gas molecules and water vapor therethrough. Because the unfunctionalized nanostructures are not electrostatically bound into the system, the coating can maintain its structure even under high humidity conditions.

In embodiments, the coatings described herein are used as a lubrication layer. As is appreciated in the art, nanostructures can be exceptional lubrication materials. For example, graphene can be a lubricant due to its free π-orbitals across the top and bottom planes. However, in general, most nanostructure-based polymer composites cannot exhibit extreme lubrication properties due to limitations in the potential nanostructure loadings stemming from nanostructure aggregation and other factors. As demonstrated herein, the coatings of the disclosure can contain high concentrations of dispersed nanostructures, which provide self-lubrication to the surface. Friction-bearing parts to which the compositions of the disclosure are applied are extremely slick to the touch and are noticeably smoother than the underlying metal surface. For example, when applied to aluminum, the coatings can render the metal so slick that quantitative measurement of the friction coefficient is difficult without advanced equipment. By a simple angle test, however, such coatings can exhibit friction coefficients as low as 0.08. The coatings can also readily repel food when used as cookware, causing bacon, eggs, or chicken to slide off the surface, similar to Teflon, but without the safety concerns associated with Teflon and other fluorocarbons.

In embodiments, the coatings described herein are used as a flame retardant coating. In embodiments, the coating can maintain its hardness, slickness, scratch resistance, and structural integrity even after heating to temperatures greater than 400° C. over an open fire.

In embodiments, the coatings described herein are used as an antimicrobial coating. In particular, current techniques that involve grafting polyelectrolytes, such as PDDAC, to surfaces are known to improve microbe resistance of the surfaces. However, these techniques generally require in-situ polymerization, toxic catalysts, and/or are not suitable for ambient, touch surfaces due to sensitivity and vulnerability of the polyelectrolyte to water. Advantageously, the compositions and coatings of the disclosure that use PDDAC and other nitrogenous functionalities can be useful in antimicrobial applications to disrupt bacteria, fungal, and viral cell membranes. Moreover, such coatings can be resistant to moisture and almost all organic solvents, including cleaners commonly used in hospitals, clean rooms, and other such environments. Advantageously, the production of these coatings is simple and includes no toxic chemicals, making them ideal for human contact surfaces. The coatings can be bacteriostatic and/or bactericidal against a range of pathogens, such as Staphylococcus Aureus, Escherichia coli, and Klebsiella pneumonia.

In embodiments, the coatings described herein are used as a scratch-resistant coating. Most polymer films are not mechanically robust compared to metallic substrates, such as aluminum. Certain exceptions, such as epoxy coatings from electro spraying, are important for a wide variety of commercial applications. However, known polymeric coatings lack many of the important properties of coatings comprising the crosslinked polyelectrolyte network of the disclosure, such as solvent resistance, self-lubrication, and smoothness. Embodiments of the disclosure provide coatings having a modulus of at least about 7, 8, 9, 10, 11, or 12 GPa and/or up to about 10, 12, 15, 16, 17, 18 or 19 GPa, for example about 7 GPa, about 9 GPa, about 10 GPa, about 12 GPa, or about 15 GPa. This is significantly higher than most epoxies.

In embodiments, the coatings described herein are used as an electrically conductive coating. In general, the dispersion of the nanostructures within the crosslinked polyelectrolyte network of the coatings according to the disclosure render the final coating electrically insulating. Advantageously, however, when the nanostructures are incorporated in amounts in excess of about 33 wt %, the coating can become electrically conductive. Such coatings can be useful for antistatic packaging or for RF shielding applications.

In embodiments, the coatings described herein are used as an oleophilic coating. Many conventional polymers of oleophilic nature (wetting to nonpolar media) tend to swell in the media, rendering them prone to fouling or coking in industrial environments. However, embodiments of the coatings of the disclosure that contain greater than about 5 wt % nanostructures can substantially be unaffected by most organic solvents, which, together with their advantageous thermal and other properties, can make them ideal for coatings in petrochemical processes, where oil wettability is desired, such as in oil-based heat exchangers.

In embodiments, the coatings described herein are used as a corrosion- or chemical-resistant coating. Because the crosslinked polyelectrolyte networks of the disclosure generally rely on electrostatic interactions to maintain cohesion, the coatings of the disclosure are not particularly vulnerable to many chemical solvation processes. While aqueous solutions with high ionic strength (e.g. brine) or detergents can affect the coatings (depending on their particular composition), the coatings can be extremely resistant to a wide range of organic solvents.

It is understood that while the disclosure is read in conjunction with the detailed description thereof, the foregoing description and following examples are intended to illustrate and not limit the scope of the disclosure, which is defined by the scope of the appended claims. Other aspects, advantages, and modifications are within the scope of the following claims.

### EXAMPLES

### Example 1

Preparation of a cationic polyelectrolyte (PE) mixture: Poly(diallyldimethyl ammonium chloride) (PDDAC) was added to pure, deionized water to form a 6 wt % PDDAC aqueous solution. The PDDAC was obtained from Millipore-Sigma (St. Louis, Mo., USA) and had a number-average molecular weight of about 200 kDa. Graphene, obtained from Celtig (Knoxville, Tenn., USA) was added to the PDDAC aqueous solution, in an amount of 1 wt %, and stirred until homogeneous. The graphene consisted of substantially pristine graphene primary nanoparticles. The graphene had a carbon content of>95%, an average diameter of about 150 nm to about 10 μm, and>65% of the nanoparticles had between 1-3 layers.

The aqueous mixture of PDDAC and graphene was placed in an ice bath and subjected to ultrasonication using a horn sonicator for 60 minutes at 1 W/g mixture. After sonication, the mixture had pH of 6.5.

Preparation of an anionic polyelectrolyte (PE) mixture: Poly(acrylic acid) (PAA) was added to pure, deionized water to form a 6 wt % PAA aqueous solution. The pH of the solution was adjusted to 2.2 using concentrated hydrochloric acid (HCl) and/or sodium hydroxide (NaOH). The PAA was obtained from Millipore-Sigma (St. Louis, Mo., USA) and had a weight-average molecular weight about 100 kDa. Graphene, the same as used in preparing the cationic polyelectrolyte mixture, was added to the PAA aqueous solution, in an amount of 1 wt %, and stirred until homogeneous. The mixture was placed in an ice bath and subjected to ultrasonication using a horn sonicator for 60 minutes at 1 W/g mixture. After sonication, the mixture had a pH of 2.4.

The cationic PE and anionic PE mixtures are summarized in Table 1, below:

TABLE 1

| | |
|---|---|
| Cationic PE Mixture | Anionic PE Mixture |

| Component | Amount (wt %) | Component | Amount (wt %) |
|---|---|---|---|
| PDDAC | 6.0 | PAA | 6.0 |
| Graphene | 1.0 | Graphene | 1.0 |
| Water | q.s. | Water | q.s. |
| pH | 6.5 | pH | 2.4 |

The cationic and anionic PE mixtures were each centrifuged at 2000 RPM for 30 minutes to remove aggregations. About 30 wt. % of the original mass of added graphene separated out as agglomerates, which corresponded to the portion of graphene nanoparticles having>3 layers. Each of the mixtures had a viscosity of about 1 Pa·s at room temperature. The mixtures were stable for at least about 6 months, at which time there was no sign of precipitation or settling of the polyelectrolytes or graphene components.

The cationic and anionic PE mixtures were then combined at a ratio of 57 wt. % anionic PE mixture at a pH of 2.4 and 43 wt. % cationic PE mixture at a pH of 6.5 under vigorous mixing for 30 minutes. The resulting aqueous mixture exhibited a pH of 2.4 and a noticeable increase in viscosity. After sitting for 30 minutes, there was no observable precipitation of any PE or graphene material. The resulting mixture is summarized in Table 2, below.

TABLE 2
Cationic PE - Anionic PE Mixture

| Component | Amount (wt %) |
|---|---|
| PDDAC | 2.6 |
| PAA | 3.4 |
| Graphene | 1.0 |
| Water | q.s. |
| pH | 2.4 |

The mixture was applied as a coating onto an aluminum surface that had been prepared for wettability by polishing with an abrasive wax, followed by vigorous washing in soap and water, and final rinsing with acetone.

After application of the mixture to the substrate, the coated substrate was placed in a 150° C. oven for 15 minutes to dry the mixture as a coating, which assumed a thickness of about 800±400 nm on the aluminum surface.

The coated substrate was then placed in a 300 mM citrate buffer containing 200 mM sodium chloride (NaCl). The pH of the buffer was adjusted to 4 using HCl and/or NaOH. The coated substrate remained in the buffer for 5 minutes to induce ionic cross-linking of the PEs and precipitation of the coating as a solid, crosslinked polyelectrolyte network adhered to the metal surface.

The coating was then rinsed with pure water to remove excess citrate solution. The composite was then dried at 150° C. for 2 minutes to remove excess water. The final graphene loading in the complex coating, after evaporation of the solvent was about 10 wt. %.

The resulting coating exhibited a Mohs hardness of between about 4-5, and passed a 10 H pencil hardness test. This Mohs hardness indicates resistance to fingernails, aluminum, wood, and all common plastics.

### Example 2

Preparation of a cationic PE mixture: Poly A cationic PE mixture was prepared as described in Example 1, this time using a branched polyethyleneimine (BPEI) to form a 10 wt % PEI aqueous mixture. The BPEI was obtained from Millipore-Sigma (St. Louis, Mo., USA) and had a number-average molecular weight of about 25 kDa. Single-walled carbon nanotubes, obtained from Cheap Tubes, Inc. (Grafton, Vt., USA) was added to the BPEI aqueous solution, in an amount of 1 wt %, and stirred until homogeneous. The SWNT had the following properties: 1-4 nm outer diameter, 500-2000 nm length,<5% multi-walled, and>90% purity. The aqueous mixture of PEI and SWNT was placed in an ice bath and subjected to ultrasonication using a horn sonicator for 60 minutes at 1 W/g mixture, after which it exhibited a pH of 7.8.

Preparation of an anionic PE mixture: Poly An anionic PE mixture was prepared as described in Example 1, using PAA to provide a 10 wt % PAA aqueous mixture. Sodium chloride was added to provide an approximately 1.5 M NaCl concentration in the mixture. The pH of the PAA aqueous mixture was adjusted to 8 using NaOH and/or HCl. Single-walled carbon nanotubes, as described with respect to the cationic PE mixture, above, were added to the PAA aqueous mixture in an amount of 1 wt %, and stirred until homogeneous. The mixture was placed in an ice bath and subjected to ultrasonication using a horn sonicator for 60 minutes at 1 W/g mixture, after which it exhibited a pH of 7.8.

The cationic PE and anionic PE mixtures are summarized in Table 3, below:

TABLE 3

| | |
|---|---|
| Cationic PE Mixture | Anionic PE Mixture |

| Component | Amount (wt %) | Component | Amount (wt %) |
|---|---|---|---|
| BPEI | 10.0 | PAA | 10.0 |
| SWCNT | 1.0 | SWCNT | 1.0 |
| Water | q.s. | Water | q.s. |
| pH | 7.8 | pH | 7.8 |

The cationic and anionic PE mixtures were each centrifuged at 2000 RPM for 30 minutes to remove aggregations. About 20 wt. % of the original mass of added SWCNT separated out as agglomerates, which corresponded to the portion of graphene nanoparticles having>3 layers. Each of the mixtures had a viscosity that was about double that of the nanotubes, alone, at room temperature. After sitting for at least about 10 months, the mixtures showed no signs of precipitation or settling of PE or SWNT components.

The cationic and anionic PE mixtures were then combined at a ratio of 50 wt. % cationic PE mixture and 50 wt % anionic PE mixture under vigorous mixing for 30 minutes. The resulting aqueous mixture exhibited a pH of 8 and a noticeable increase in viscosity, indicating the onset of interaction and association between the PEs. However, after sitting for at least about 1 minute, there was no observable precipitation of any PE or SWCNT material. The resulting mixture is summarized in Table 4, below.

TABLE 4
Cationic PE - Anionic PE Mixture

| Component | Amount (wt %) |
|---|---|
| BPEI | 5.0 |
| PAA | 5.0 |
| SWCNT | 1.0 |
| Water | q.s. |
| pH | 8 |

The mixture was applied by blade coating onto a polyethylene terephthalate (PET) web (substrate), the surface of which had been prepared for wettability by thorough cleaning and corona discharge. The coating had a thickness of approximately 2.5 μm, and was substantially transparent on the underlying PET surface.

After application of the mixture to the substrate, the coated substrate was placed in a 150° C. oven for 15 minutes to dry the mixture as a coating, which assumed a thickness of about 1-5 μm on the PET surface.

The coated substrate was then placed in a citrate solution, prepared as in accordance with Example 1, for 5 minutes to induce ionic cross-linking of the PEs and precipitation of the coating as a solid, crosslinked polyelectrolyte network adhered to the PET surface.

The coating was then rinsed with pure water to remove excess citrate solution. The composite was then dried at 150° C. for 2 minutes to remove excess water. The coating was optically clear. The final SWNT loading in the nanocomposite coating was about 7 wt. %.

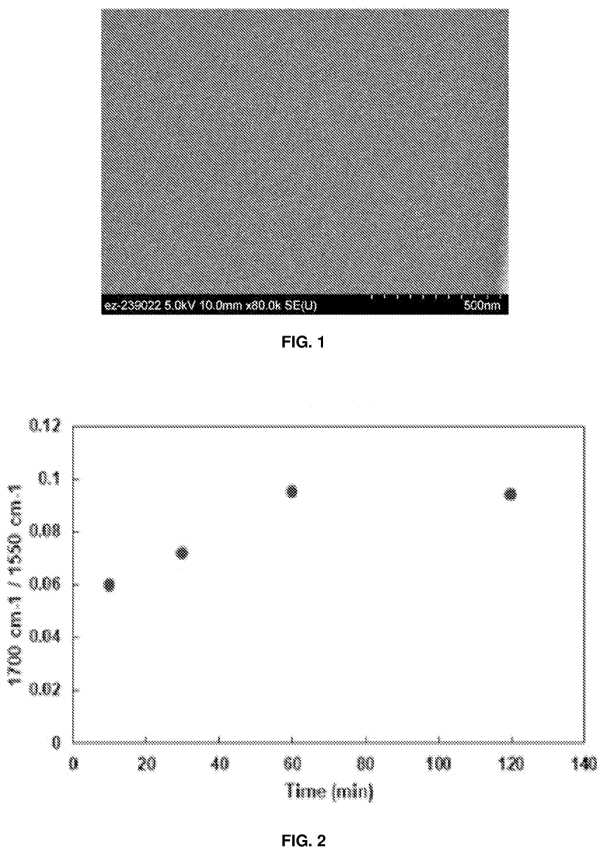

To demonstrate dispersion of nanostructures in the crosslinked PE network coatings applied to substrates, a scanning electron microscopic (SEM) image was obtained (scale=500 nm), as shown in FIG. 1. FIG. 1 shows that, despite the high nanostructure loading, there were no visible “ropes” or aggregates of SWCNT, as are ordinarily observed in mixtures containing such nanotubes. The coating was slightly dark in color, yet optically clear and optically homogeneous.

### Example 3

Preparation of a cationic PE mixture: A 10 wt % PDDAC aqueous mixture was prepared in accordance with the foregoing examples. Multi-walled carbon nanotubes (MWCNTs), obtained from Cheap Tubes, Inc. (Grafton, Vt., USA) were added in an amount of 1 wt % and stirred until homogenous. The MWCNT was substantially pristine MWCNT nanostructures having the following properties:10-20 nm diameter, 10-30 μm length, >95% purity. The aqueous mixture of PDDAC and MWCNT was placed in an ice bath and subjected to ultrasonication using a horn sonicator for 60 minutes at 1 W/g mixture, after which it exhibited a pH of 6.5.

Preparation of an anionic PE mixture: A 10 wt % polystyrene sulfonate (PSS) aqueous mixture was prepared in accordance with the foregoing examples. The PSS, obtained from Millipore-Sigma (St. Louis, Mo., USA) had a molecular weight of about 200 kDa. The pH of the PSS mixture was adjusted to 8 by pH meter using NaOH and/or HCl. Multi-walled carbon nanotubes, as described above 2, were added in an amount of 1 wt % and stirred until homogenous. The mixture was placed in an ice bath and subjected to ultrasonication using a horn sonicator for 60 minutes at 1 W/g mixture, after which it exhibited a pH of 6.5.

The cationic PE and anionic PE mixtures are summarized in Table 5, below:

TABLE 5

| | |
|---|---|
| Cationic PE Mixture | Anionic PE Mixture |

| Component | Amount (wt %) | Component | Amount (wt %) |
|---|---|---|---|
| PDDAC | 10.0 | PSS | 10.0 |
| MWCNT | 1.0 | MWCNT | 1.0 |
| Water | q.s. | Water | q.s. |
| pH | 6.5 | pH | 6.5 |

The cationic and anionic PE mixtures were centrifuged at 2000 RPM for 30 minutes to remove aggregations. About 10 wt. % of the original mass of added MWNT separated out as agglomerates. The resulting mixtures were homogeneous, indicating substantially complete dispersion of the MWCNT nanostructures therein and no discernable precipitation of PE material. Adding the nanotubes about doubled the viscosity of both mixtures at room temperature. After sitting for at least about 2 months, the mixtures showed no signs of precipitation of PE or MWCNT components.

The ionic strength of the PSS and PDDAC mixtures was adjusted by dissolving enough NaCl into the mixtures until they exhibited a concentration of 3.5 M NaCl.

The cationic and anionic PE mixtures were then combined at a ratio of 50 wt. % cationic PE mixture and 50 wt % anionic PE mixture under vigorous mixing for 30 minutes. The resulting aqueous mixture exhibited a noticeable increase in viscosity, indicating the onset of interaction and association between the PEs. However, after sitting for at least 1 week, there was no observable precipitation of any PE or MWCNT material. The resulting mixture is summarized in Table 6, below.

TABLE 6
Cationic PE - Anionic PE Mixture

| Component | Amount (wt %) |
|---|---|
| PDDAC | 5.0 |
| PSS | 5.0 |
| MWCNT | 1.0 |
| Water | q.s. |
| pH | 8 |

The mixture was applied to a sheet of glass (substrate), the surface of which had been prepared for wettability by treatment with piranha solution. The coating had a thickness of approximately 5 μm, and was substantially transparent.

After application of the mixture to the substrate, the coated substrate was placed in a 150° C. oven for 30 minutes to dry the mixture as a coating, which assumed a thickness of about 1 μm on the glass surface.

The coated substrate was then placed in a 70 vol. % aqueous solution of isopropanol to remove salt from the coating without dissolution of the same, and to induce ionic cross-linking of the PEs and precipitation of the coating as a solid, crosslinked polyelectrolyte network adhered to the glass surface.

The coating was then rinsed with pure water and dried at 150° C. for 2 minutes to remove excess alcohol and residual sodium chloride. The removal of the salt rendered the coating insoluble in pure water. The coating was optically clear. The loading of the MWNT in the final coating was about 9 wt. %.

### Example 4

To demonstrate the viability of introducing covalent crosslinking to synergize with the electrostatic interactions, a multi-functional alcohol (glycerol) was added to the deposition mixture, which forms ester crosslinks with the anionic polyelectrolyte upon drying.

Preparation of a cationic PE mixture: An 8 wt % PDDAC, 1 wt % graphene aqueous mixture was prepared in accordance with the foregoing examples. The aqueous mixture of PDDAC and graphene was placed in an ice bath and subjected to ultrasonication using a horn sonicator for 60 minutes at 1 W/g mixture, after which it exhibited a pH of 6.5.

Preparation of an anionic PE mixture: An 8 wt % PAA, 1 wt % graphene aqueous mixture was prepared in accordance with the foregoing examples. The pH was adjusted to 2.2 using HCl and/or NaOH.

A 500 mM citrate buffer curing solution, having a pH 3.5 was prepared.

The cationic PE and anionic PE mixtures are summarized in Table 7, below:

TABLE 7

| | |
|---|---|
| Cationic PE Mixture | Anionic PE Mixture |

| Component | Amount (wt %) | Component | Amount (wt %) |
|---|---|---|---|
| PDDAC | 8.0 | PAA | 8.0 |
| Graphene | 1.0 | Graphene | 1.0 |
| Water | q.s. | Water | q.s. |
| pH | 6.5 | pH | 2.2 |

The cationic and anionic PE mixtures were centrifuged at 2000 RPM for 30 minutes to remove aggregations. About 30 wt. % of the original mass of added graphene separated out as agglomerates. The resulting mixtures were homogeneous, indicating substantially complete dispersion of the graphene nanoparticles therein and no discernable precipitation of PE material. Both mixtures exhibited a viscosity of about ˜1 Pas at room temperature. After sitting for at least about 6 months, the mixtures showed no signs of precipitation of PE or graphene components.

The cationic and anionic PE mixtures were then combined at a ratio of 70 wt. % anionic PE mixture, 26.5 wt. % cationic PE mixture, with 2.7 wt. % anhydrous glycerol (glycerin) under vigorous mixing for 30 minutes. The resulting aqueous mixture exhibited a pH of 2.4 and a noticeable increase in viscosity, indicating the onset of interaction and association between the PEs. However, after sitting for at least about 30 min, there was no observable precipitation of any PE or graphene material. The resulting mixture is summarized in Table 8, below.

TABLE 8
Cationic PE - Anionic PE Mixture

| Component | Amount (wt %) |
|---|---|
| PDDAC | 2.1 |
| PAA | 5.6 |
| Graphene | 1.0 |
| Glycerol | 2.7 |
| Water | q.s. |
| pH | 2.4 |

The mixture was applied as a coating directly onto a polyester surface (substrate) that had been prepared for wettability by corona-discharge treatment in air.

After application of the mixture to the substrate, the coated substrate was placed in a 150° C. oven for 3 minutes to dry the mixture as a coating and induce covalent crosslinking between the PAA and glycerol.

The coated substrate was then placed in the citrate buffer for 5 minutes to induce ionic cross-linking of the PEs and precipitation of the coating as a solid, crosslinked polyelectrolyte network adhered to the polyester surface.

The coating was then rinsed with pure water to remove excess citrate solution. The composite was then dried at 150° C. for 60 minutes to complete the covalent crosslinking between the glycerol and PAA. The final graphene loading in the coating was estimated to be about 7 wt. %.

### Example 5

A series of mixtures of PEI/PAA and PDDAC/PAA with SWCNTs were prepared at several different pH values and for which the ionic strength was adjusted by progressively increasing salt concentrations.

A PEI/PAA mixture having 1 wt. % SWNT at pH 8 and no NaCl provided a solid composition. As the concentration of NaCl was increased, the mixture formed a two-liquid phase coacervate system. With enough NaCl, the mixture formed a homogeneous, one phase liquid solution. However, the nanostructures remained in the polymer-rich phase, whether solid, coacervate, or liquid. Additionally, a PEI/PAA mixture with 1 wt. % SWNT at pH 6 was found to be solid.

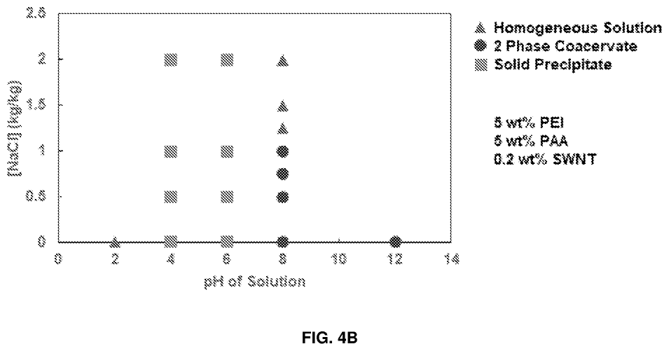

FIG. 4A shows that pH and salt concentration can affect the phase of a PDDAC/PAA composition having 0.2 wt % SWCNTs in accordance with an embodiment of the disclosure. FIG. 4B shows that pH and salt concentration can affect the phase of a PEI/PAA composition having 0.2 wt % SWCNTs in accordance with an embodiment of the disclosure. The data demonstrate that the compositions in accordance with the disclosure can exist across a range of solution states and the solution states can be tailored for a desired application.

### Example 6

To illustrate the beneficial properties of coatings as applied to substrates the composition of Example 1 was applied to a number of different substrates, as described below:

Carbon Steel Shaft. A carbon steel shaft was first dipped into a mixture of 10 wt. % PDDAC and 1 M NaOH for 30 seconds (pH 14), rinsed thoroughly with distilled water, and then rinsed immediately with acetone in order to improve adhesion of the coating to the surface of the shaft. The shaft was then coated with the PDDAC/PAA/graphene mixture prepared according to Example 1. It was then placed in a 150° C. convection oven to dry for 30 minutes. After drying, the shaft was allowed to cool and then dipped into a pH 3 citrate buffer (300 mM with 200 mM NaCl added) for 5 minutes. After exposure to the buffer, then shaft was rinsed thoroughly with distilled water and then placed in the oven at 150° C. to dry for 5 minutes.

Carbon Steel Rollers. The process for coating the surfaces of small steel bearing rollers (roughly 8 mm in diameter) was identical to the carbon steel shaft.

Carbon Steel Pistons. The surfaces of these parts were coated in an identical manner to the carbon steel shaft.

Anodized Aluminum Cylinders. There was no pretreatment performed on the cylinder surfaces to be coated, aside from removing any oil on the surface using soap and water and rinsing with alcohol. The cylinder surface was coated with the PDDAC/PAA/graphene mixture and treated as described for the shaft.

Aluminum Holders for the Shaft. The aluminum surfaces were polished using turtle wax prior to deposition. Any wax was removed using acetone before coating. After polishing, there was no additional pre-treatment before applying the coating to the surfaces, identical to the aluminum cylinders.

Nitride-Treated Carbon Steel Cam. The cam required no pre-treatment of its surface for good adhesion, and was therefore coated immediately after washing any oil off using soap and water as described for the aluminum parts.

All the coatings were de-burred (removing any defects or drip lines) by first rubbing the surface vigorously with a rough cloth and a drop of motor oil, which helped carry away any particulates. The coating was then scraped with a brass scraper, removing any loosely adhered material. Oil was then removed by vigorously drying with a paper towel and rinsing with acetone.

The coatings on the parts were extremely smooth and uniform, felt exceedingly slick to the touch, and appeared to take up no smear or body oil residue from the finger. Upon installation and assembly of the compressor with the coated parts, the compressor was operated continuously for an extended period of time (i.e., 30 min.). The parts were cool after the 30 minute run, and no coated surface showed any discernable damage or wear, indicating a low friction operation without any external or applied lubrication. The compressor was only operated for 3 minute intervals, hence, the 30 minute run was considered a good test of the tribological and other properties of metal parts coated with the compositions of the disclosure.

### Example 7

To evaluate the use of an alcohol as a crosslinking agent to induce covalent crosslinking of the anionic and cationic PEs, several alcohols were tested, including butanol, 1,3-propanediol, ethylene glycol, glycerol, 1,1,1-tris(hydroxymethyl)propane, and polyvinyl alcohol. Each of these alcohols were added to PDDAC/PAA compositions at a temperature of 140° C. or slightly higher for about 30 minutes. The graphene, as used in Example 1, was used as the nanostructures. The compositions were applied to a corona-treated polyester coating substrate, and heated to about 140° C. for about 30 minutes, which was in excess of the time and temperature expected to induce covalent crosslinking. The coated substrate was cooled and dipped into a citrate buffer at a pH of 3.5 for about 10 minutes to induce ionic crosslinking. The coated substrate was then dried at about 140° C. for about 30 minutes to remove excess solvent and impurities.

The conversion of carboxylic acid to ester was determined by FTIR. Results are shown in Table 10, below. Table 10 additionally shows whether the resulting coatings were resistant to saturated NaCl and 5 wt % detergent solutions. The maximum PDDAC amount before appearance of solids in coatings cast from compositions having a 1:2:1 alcohol:PAA:PDDAC ratio is also provided.

TABLE 10

| | Number | Ester | | | PDDAC |
|---|---|---|---|---|---|
| | of OH | mol % | NaCl | Detergent | wt % |
| | groups | conversion | resistance | resistance | limit |
| Butanol | 1 | <1 | Fail | Fail | >50 |
| 1,3-propanediol | 2 | 12 | Pass | Fail | >50 |
| Ethylene glycol | 2 | 9 | Fail | Fail | >50 |
| Glycerol | 3 | 34 | Pass | Pass | >50 |
| 1,1,1-Tris(hydroxymethyl)propane | 3 | 25 | Pass | Pass | ~10 |
| Polyvinyl alcohol | >500 | 40 | Pass | Pass | ~3 |

From Table 10, it can be seen that salt and detergent resistance generally increased as the number of OH functionalities increased. Additionally, a relationship was found to exist between PDDAC concentration and the functionality contributed by the alcohol. Hydrogen bonding between the quaternary ammonium of the PDDAC and the hydroxyl group of the alcohol was believed to have contributed to some undesirable precipitation, which could not be readily separated by centrifugation, leading to relatively poor coating quality.

Among the alcohols tested, glycerol was found to enable relatively high loadings of PDDAC and adequate salt and detergent resistance. Additionally, glycerol is nontoxic, inexpensive, easy to clean, and appeared to aid in coating formation. Without intending to be bound by theory, it was believed that the glycerol acted as a plasticizer during drying.

Additional PDDAC/PEI/graphene compositions were made using glycerol. From these compositions, it was observed that a stoichiometric amount of glycerol to PAA was not ideal, as the coating could not survive curing. Without intending to be bound by theory, this was believed to be due to the PDDAC having no anion with which to interact. Instead, excess PAA was required to balance the covalent crosslinking with the electrostatic crosslinking.

Under the test conditions, a 3-minute bake at 140° C. was determined to be sufficient to initiate the crosslinking process and to avoid excessive loss of glycerol during the cure step. A post bake was used to finish the crosslinking. It was also found that 5 minutes at 140° C. was sufficient to provide a coating containing the crosslinked polyelectrolyte network for which no noticeable dissolution or other adverse effects were observed when left in contact with brine. However, resistance to detergent was improved with heating for additional time. Nevertheless, there appeared to be little benefit to curing for more than 60 minutes, which was also indicated by a plateau in the FTIR signal associated with the formation of ester linkages, as shown in FIGS. 2A and 2B.

### Example 8

### Preparation of a Bake-Free Coating

The coatings prepared from the compositions of the disclosure were evaluated for durable, long-term antimicrobial properties.

Preparation of a cationic PE aqueous mixture. A cationic polyelectrolyte mixture was prepared as a mixture of two cationic polyelectrolytes, poly(diallyldimethyl ammonium) chloride (PDDAC) and branched polyethyleneimine (“BPEI”) at a ratio of about 5:1 by weight in water. The pH of the mixture was kept low to prevent precipitation during the final mixing step. Specifically, an aqueous composition comprising 6 wt. % (120 kg) PDDAC and 1.2 wt. % (24 kg) BPEI was prepared, and sufficient concentrated HCl was added (about 1-3 wt % (−50 kg) of 37% HCl) with mild stirring to maintain the pH below about 4.2. The PDDAC had a number-average molecular weight of about 250-500 kDa, and the BPEI had a number-average molecular weight of about 10 kDa.

To this mixture was admixed about 0.3 wt % (6 kg) graphene nanoparticle powder, as described in Example 1. The mixture was stirred until homogeneous and then subjected to shear mixing for at least about 1 hour at 3000 RPM to promote dispersion of the graphene nanoparticles in and by means of association with PDDAC/BPEI chains.

Preparation of an anionic PE aqueous mixture. An anionic polyelectrolyte mixture was prepared by mixing solid PAA in water together with concentrated HCl sufficient to provide an aqueous mixture of PAA having a pH of less than about 2, preferably from about 1.5-1.8. The pH of the mixture was kept low in order to limit premature or undesired complexation and other adverse effects during the later steps. Specifically, an aqueous composition comprising 6 wt. % (120 kg) PAA was prepared, and sufficient concentrated HCl was added (about 0.1 wt % (−2 kg) of 37% HCl) with mild stirring to maintain the pH below about 2. The PAA had a number-average molecular weight of about 250 kDa.

The PAA mixture was stirred until substantially homogeneous. To this mixture, about 0.3 wt % (6 kg) graphene nanoparticle powder was added, and the mixture was subjected to shear mixing for at least about 1 hour at 3000 RPM to promote dispersion of graphene nanoparticles in and by means of association with PAA chains.

Preparation of composition for coating. The anionic PE-graphene and cationic PE-graphene mixtures were combined in a 1:1 ratio, by weight, under gradual admixing conditions while also admixing 50 wt. % (56 vol. %) of pure isopropyl alcohol (IPA) with close control to avoid any precipitation of solids. Any apparent cloudiness dissipated with sufficient mixing under carefully controlled conditions, resulting in a mixture that was substantially clear.

Preparation of a curing solution. An ammonium acetate/acetic acid buffer solution was used for curing. Specifically, the solution was prepared by combining 5 wt % aqueous acetic acid (AA) with 5 wt % aqueous ammonia or ammonium acetate, and adjusted with an excess of acetic acid until the pH was about 3.9-4.

The alcohol-diluted anionic-cationic composition was applied by spraying onto a surface to be treated in a manner and at a rate sufficient to form a substantially continuous coating and to avoid formation of drip lines and the like. The composition was allowed to dry. The curing solution was sprayed onto the dry coating to induce final ionic crosslinking and formation of a solid crosslinked polyelectrolyte network having from about 1 wt % to about 5 wt % graphene nanoparticles dispersed therein. No curing by heating was used. The final, cured coating had about 44.3 wt % PAA, about 44.3 wt % PDDAC, about 9.2 wt % BPEI, and about 4.3 wt % graphene.

The resulting coating exhibited substantial durability and hardness against wiping and abrasion. The coating also had a very low friction coefficient (as low as 0.15) and was resistant to displacement by surface cleaning contact and chemical cleaners. The coating had long-term antimicrobial properties.

### Example 9

### Applications of the Compositions

The following example illustrates some applications of the compositions according to the disclosure.

### Gas/Vapor Barrier

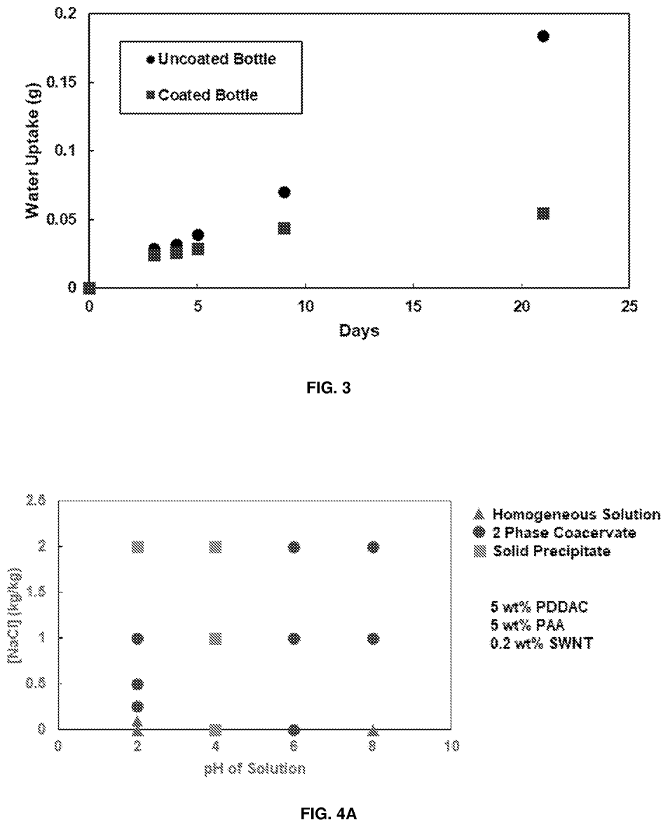

The composition of Example 1 was evaluated for its gas/vapor barrier properties. As shown in FIG. 3, water vapor transmission through a plastic soda bottle having the composition of Example 1 applied thereto took up significantly less water over the course of more than 20 days than a comparative plastic soda bottle having no coating thereon.

### Antimicrobial Coating—Example 1 Composition

The composition of Example 1 was evaluated for its antimicrobial properties. Specifically, the composition of Example 1 was prepared and applied to a polyester substrate. The final, clear coating comprised 45.6 wt % PAA, 34.4 wt % PADDC, and 20 wt % graphene.

The coated polyester substrate was tested in triplicate according to Japanese Industrial Standard Z 2801 Antibacterial Products—Test for Antibacterial Activity and Efficacy against an uncoated polyester substrate (also in triplicate), both for their resistance to Staph. Aureus ATCC 6538 Results are shown in Table 11, below.

TABLE 11

| | | | | Average | | |
|---|---|---|---|---|---|---|
| Contact | | | CFU/ | CFU/ | | |
| Time | Test | Repli- | Carrier | Carrier | % | Log₁₀ |
| (hr) | Material | cate | (×10³) | (×10³) | Reduction | Reduction |
| 0 | Uncoated | 1 | 220 | 190 | — | |
| | Polyester | 2 | 205 | | | |
| | | 3 | 145 | | | |
| 24 | Uncoated | 1 | 155 | 183 | — | |
| | Polyester | 2 | 270 | | | |
| | | 3 | 125 | | | |
| | Coated | 1 | 0.300 | 0.278 | 99.85 | 2.82 |
| | Polyester | 2 | 0.300 | | | |
| | | 3 | 0.235 | | | |

As shown by the data in Table 11, there was a substantial reduction of microbial population on a relatively heavily contaminated substrate having a coating comprising the crosslinked polyelectrolyte network of the disclosure compared to an uncoated surface of an identical substrate. These results indicated that the coating of the disclosure not only limited the growth of pathogens, but was itself toxic to such organisms, leading to substantial reduction in their population over time.

### Antimicrobial Coating—Example 8 Composition

The composition of Example 8 was evaluated for its antimicrobial properties. Specifically, the composition of Example 8 was prepared and applied to a polyethylene terephthalate (PET) substrate. Samples coated with only the dry PDDAC/PAA/graphene coating were tested, as well as samples coated with the dry PDDAC/PAA/graphene coating+the dry ammonium acetate buffer curing layer.

The coated PET substrates were tested in triplicate according to Japanese Industrial Standard Z 2801 Antibacterial Products—Test for Antibacterial Activity and Efficacy against an uncoated PET substrate (also in triplicate), for their resistance to S. Aureus ATCC 6538P, E. coli ATCC 8739, and K. pneumonia ATCC 4352. Results are shown in Table 12, below.

TABLE 12

| | | | |
|---|---|---|---|
| | | | PET + |
| | Uncoated | PET + | Coating + |
| ⁺Average CFU/Carrier (×10³) | PET | Coating | Buffer |

| S. aureus | After inoculation⁺ | | 10 |
|---|---|---|---|
| | After 24 hr⁺ | Blank | 25 |

| | | | |
|---|---|---|---|
| Test specimen | 54 | <0.00063 | <0.00063 |

| | | | |
|---|---|---|---|
| Log₁₀ reduction | 0 | 4.5 | 4.5 |
| % Reduction | — | 99.99 | 99.99 |

| E. coli | After inoculation⁺ | | 13 |
|---|---|---|---|
| | After 24 hr⁺ | Blank | 920 |

| | | | |
|---|---|---|---|
| Test specimen | 630 | 0.63 | 0.32 |

| | | | |
|---|---|---|---|
| Log₁₀ reduction | 0.1 | 3.1 | 3.4 |
| % Reduction | 31.52% | 99.93 | 99.96 |

| K. | After inoculation⁺ | | 13 |
|---|---|---|---|
| pnuemonia | After 24 hr⁺ | Blank | 450 |

| | | | |
|---|---|---|---|
| Test specimen | 910 | 0.020 | 1.6 |

| | | | |
|---|---|---|---|
| Log₁₀ reduction | 0 | 4.3 | 2.4 |
| % Reduction | — | 99.99 | 99.64 |

As shown by the data in Table 12, there was a substantial reduction of microbial population on a relatively heavily contaminated PET substrate having a coating comprising each of the dried PDDAC/PAA/graphene composition, as well as the coating comprising the dried PDDAC/PAA/graphene composition+the ammonium acetate curing solution, as compared to an uncoated surface of an identical substrate. These results indicated that the non-baked (i.e., not cured in the oven) coating of the disclosure not only limited the growth of pathogens, but was itself toxic to such organisms, leading to substantial reduction in their population over time.

The composition of Example 8 was further evaluated for its antimicrobial properties on a polyurethane (PU) foam substrate. Samples coated with only the dry PDDAC/PAA/graphene coating were tested, as well as samples coated with the dry PDDAC/PAA/graphene coating+the dry ammonium acetate buffer curing layer.

The coated PU substrates were tested in triplicate according to AATCC TM 100: 2019 test method, for their resistance to Staph. Aureus ATCC 6538, E. coli ATCC 8739, and K. pneumonia ATCC 4352. The AATCC 100 test method evaluates the antibacterial properties of textiles over a 24-hour period of contact, quantitatively assessing bacteriostatic (growth inhibition) or bactericidal (killing of bacteria) properties. Results are shown in Table 13, below.

TABLE 13

| | | | | PU + |
|---|---|---|---|---|
| | | Uncoated | PU + | Coating + |
| | | PU | Coating | Buffer |
| S. aureus | C (×10⁵) | 1.7 | 1.7 | 1.7 |
| | A (×10⁵) | 31 | <0.001 | <0.001 |
| | Percent Reduction (%) | — | 99.99 | 99.99 |
| E. coli | C (×10⁵) | 1.7 | 1.8 | 1.4 |
| | A (×10⁵) | 38 | <0.001 | <0.001 |
| | Percent Reduction (%) | — | 99.99 | 99.99 |
| K. | C (×10⁵) | 1.5 | 1.5 | 1.5 |
| pnuemonia | A (×10⁵) | 22 | <0.001 | <0.001 |
| | Percent Reduction (%) | — | 99.99 | 99.99 |

C: the number of bacteria recovered from the inoculated treated test specimen swatches in the jar immediately after inoculation: at “0” contact time.
A: the number of bacteria recovered from the inoculated treated test specimen swatches in the jar incubated over 24 hours.
% Reduction = ((C − A) × 100)/C

As shown by the data in Table 13, there was a substantial reduction of microbial population on a relatively heavily contaminated PU substrate having a coating comprising each of the dried PDDAC/PAA/graphene composition, as well as the coating comprising the dried PDDAC/PAA/graphene composition +the ammonium acetate curing solution, as compared to an uncoated surface of an identical substrate. These results indicated that the non-baked (i.e., not cured in the oven) coating of the disclosure not only limited the growth of pathogens, but was itself toxic to such organisms, leading to substantial reduction in their population over time.

### Corrosion and Chemical Resistant Coatings

Coatings prepared from the PAA/PDDAC composition of Example 1 were applied a polyester film and exposed to an array of solvents and fluids for 30 days. After each week, the films were briefly removed from the solvent, vigorously wiped with a paper towel, and then scratched with a brass hook. If the film had any visible damage, the test was a failure. Any film that survived was exposed to 24 hours of ultrasonication in the solvent, and the same test was repeated.

The PAA/PDDAC coating on polyester survived, without any noticeable damage, in the following solvents: HCl, H₂SO_{4,} methanol, acetone, dichloromethane, dichloroethane, dimethylformamide, dimethyl sulfoxide, toluene, heptane, hexane, pentane, paraffin oil, cutting oil, and vacuum oil.

### Flame Retardant Coating

The composition of Example 1 was used to provide a coating on an aluminum substrate. The coated substrate was heated over an open flame to a temperature of greater than 400° C. to simulate its use in a cookware application. After heating for over 15 minutes at maximum heat, the coating maintained its hardness, slickness, scratch resistance, and structural integrity. The coating exhibited minor flaking near the top of the coating when food first touched the metal, which was believed to be due to thermal contraction.

### Electrically Conductive Coating

A coating prepared in accordance with the disclosure was applied to aluminum substrate. In particular, the coating of Example 1 was used, except it contained 3 wt % graphene to 6 wt % polyelectrolyte. The conductivity of the coating was determined to be about 6 S/m.

What is claimed is:

1. An aqueous composition for forming a coating, comprising:
a cationic polyelectrolyte;
an anionic polyelectrolyte;
nanostructures; and,
a crosslinking agent,
wherein the nanostructures are present in an amount of about 0.025 wt % to 10 wt %, based on the total weight of the composition.

2. A composition for forming a coating, comprising:
a cationic polyelectrolyte;
an anionic polyelectrolyte:
nanostructures;
a non-water solvent; and,
a crosslinking agent,
wherein the nanostructures comprise unfunctionalized graphene nanoparticles.

3. The composition of claim 1 or 2, wherein the nanostructures are present in an amount of about 0.025 wt % to about 7 wt %.

4. The composition of claim 2 or 3, wherein the non-water solvent comprises ethanol, acetone, methanol, isopropanol, or a mixture thereof.

5. The composition of any one of the preceding claims, wherein the crosslinking agent comprises one or more of 1,3-propanediol, ethylene glycol, glycerol, tris(hydroxymethyl)propane, polyethyleneimine (PEI), and polyvinyl alcohol (PVOH).

6. The composition of any one of the preceding claims, wherein the crosslinking agent comprises glycerol, branched polyethyleneimine (BPEI), or both.

7. The composition of any one of the preceding claims, wherein the crosslinking agent is present in an amount of about 0.1 wt % to about 20 wt %, based on the total weight of the composition.

8. The composition of any one of the preceding claims, wherein the cationic polyelectrolyte comprises one of more of poly(diallyldimethyl ammonium) chloride (PDDAC), branched polyethyleneimine (BPEI), chitosan, polyvinyl alcohol (PVOH), poly(allylamine), polyvinylamine, polyvinyl formamide, a cationic polyamino acid, and a cationic protein.

9. The composition of any one of the preceding claims, wherein the anionic polyelectrolyte comprises one or more of polyacrylic acid (PAA), poly(styrene sulfonate) (PSS), a polyacid, polymethacrylic acid, polyethylene sulfonate, polypropylene sulfonate, an anionic polyamino acid, and an anionic protein.

10. The composition of any one of the preceding claims, wherein the anionic polyelectrolyte and the cationic polyelectrolyte each have a number-average molecular weight (Mₙ) of about 1 kDa to about 400 kDa.

11. The composition of claim 10, wherein the anionic polyelectrolyte and the cationic polyelectrolyte each have a Mₙ of about 10 kDa to about 200 kDa.

12. The composition of any one of the preceding claims, wherein the cationic polyelectrolyte is present in an amount of about 1 wt % to about 20 wt %, based on the total weight of the composition.

13. The composition of any one of the preceding claims, wherein the anionic polyelectrolyte is present in an amount of about 1 wt % to about 10 wt %, based on the total weight of the composition.

14. The composition of any one of the preceding claims, wherein the cationic polyelectrolyte and anionic polyelectrolyte are present in a weight ratio of about 1:4 to about 4:1.

15. The composition of any one of claims 1 and 3-14, wherein the nanostructures comprise one or more of graphene nanoparticles, single-wall carbon nanotubes (SWCNTs), multi-wall carbon nanotubes (MWCNTs), silver nanowires, and hexagonal boron nitride.

16. The composition of claim 15, wherein the graphene nanoparticles are unfunctionalized.

17. The composition of anyone of the preceding claims, wherein the nanostructures comprise graphene nanoparticles, wherein at least 50% of the graphene nanoparticles have 10 layers or less.

18. The composition of any one of the preceding claims, wherein the nanostructures comprise single-wall carbon nanotubes (SWCNTs).

19. The composition of any one of the preceding claims, wherein the composition has a pH of about 2 to about 9.

20. The composition of any one of the preceding claims, wherein the composition is free of an added dispersant.

21. The composition of any one of the preceding claims, wherein:
the cationic polyelectrolyte comprises poly(diallyldimethyl ammonium) chloride (PDDAC);
the anionic polyelectrolyte comprises polyacrylic acid (PAA);
the nanostructures comprise graphene nanoplatelets or single-wall carbon nanotubes (SWCNTs); and,
the crosslinking agent comprises branched polyethyleneimine (BPEI).

22. An antimicrobial coating comprising the composition of any one of the preceding claims.

23. A coating comprising:
a crosslinked polyelectrolyte network comprising a cationic polyelectrolyte and an anionic polyelectrolyte; and,
nanostructures dispersed in the crosslinked polyelectrolyte network,
wherein the nanostructures are present in an amount of about 1 wt % to about 50 wt %, based on the total weight of the coating, and the coating has a pencil hardness of at least 6 H.

24. The coating of claim 23, wherein the nanostructures are present in an amount of at least 10 wt %, based on the total weight of the coating.

25. The coating of claim 23 or 24, wherein the cationic polyelectrolyte and the anionic polyelectrolyte are crosslinked via covalent bonds to form the crosslinked polyelectrolyte network.

26. The coating of claim 25, wherein the cationic polyelectrolyte and the anionic polyelectrolyte are crosslinked via ester bonds, amide bonds, or both to form the crosslinked polyelectrolyte network.

27. The coating of claim 23, wherein the nanostructures are present in an amount of about 1 wt % to about 10 wt %, based on the total weight of the coating.

28. The coating of claim 27, wherein the crosslinked polyelectrolyte network is free of covalent crosslinking.

29. The coating of any one of claims 23-28, provided on or adjacent a surface of a substrate.

30. The coating of any one of claims 23-28, wherein the coating is a self-supporting film.

31. A method comprising:
admixing:
an aqueous solution comprising a cationic polyelectrolyte;
an aqueous solution comprising an anionic polyelectrolyte; and
a crosslinking agent;
thereby providing a coating solution,
wherein each of the aqueous solution comprising the cationic polyelectrolyte and the aqueous solution comprising the anionic polyelectrolyte comprise nanostructures dispersed therein;
the aqueous solution comprising the cationic polyelectrolyte has a pH of about 7.5 or less; and,
the aqueous solution comprising the anionic polyelectrolyte has a pH of less than about 2.

32. The method of claim 31, wherein the aqueous solution comprising the anionic polyelectrolyte has a pH of about 1.5 to about 1.8.

33. The method of claim 31 or 32, wherein the coating solution has a pH of about 1.5 to about 7.5.

34. The method of any one of claims 31-33, wherein the coating solution further comprises a non-water solvent, wherein the solvent is polar and fully miscible with water.

35. The method of claim 34, wherein the solvent is one or more of ethanol, methanol, acetone and isopropanol.

36. The method of any one of claims 31-35, further comprising applying the coating solution on or adjacent to a surface of a substrate to provide a coated substrate.

37. The method of claim 36, further comprising applying a curing solution on or adjacent the coated substrate to provide a curable coated substrate.

38. The method of claim 37, wherein the curing solution comprises a buffering agent.

39. The method of claim 38, wherein the buffering agent comprises one or more of phosphate, citrate, and ammonium acetate.

40. The method of any one of claims 31-39, further comprising heating the curable coated substrate to a temperature of at least about 100° C., thereby covalently crosslinking the cationic polyelectrolyte and the anionic polyelectrolyte to form a crosslinked polyelectrolyte network having the nanostructures dispersed therein.

41. The method of any one of claims 30-40, wherein the crosslinking agent comprises one or more of 1,3-propanediol, ethylene glycol, glycerol, tris(hydroxymethyl)propane, polyethyleneimine (PEI), and polyvinyl alcohol (PVOH).

42. The method of claim 41, wherein the crosslinking agent comprises glycerol, branched polyethyleneimine (BPEI), or both.

43. A method of coating a substrate comprising:
applying a coating solution to a surface of a substrate, thereby providing a coated substrate, the coating solution comprising an admixture of:
(a) an aqueous cationic polyelectrolyte solution comprising a cationic polyelectrolyte and nanostructures dispersed therein;
(b) an aqueous anionic polyelectrolyte solution comprising an anionic polyelectrolyte and nanoparticles dispersed therein; and,
(c) a crosslinking agent;
applying a curing solution to the coated substrate, thereby providing a curable coated substrate; and,
drying the curable coated substrate, thereby crosslinking the cationic polyelectrolyte and the anionic polyelectrolyte to form a crosslinked polyelectrolyte network having nanoparticles dispersed therein on the surface of the substrate.

44. The method of claim 43, further comprising heating the curable coated substrate to a temperature of at least about 100° C.

45. The method of claim 43 or 44, wherein each of the coating solution and the curing solution is applied to the substrate via dipping, spraying, painting, or wiping.

46. The method of any one of claims 43-45, wherein the coating solution comprises a solvent, the solvent comprising one or more of water, acetone, ethanol, methanol, and isopropanol.

47. The method of any one of claims 43-46, wherein the curing solution comprises ammonium acetate and has a pH of about 3 to about 7.5.

48. The method of claim 47, wherein the curing solution has a pH of about 3.9 to about 4.

49. A kit for coating a substrate comprising:
a coating solution comprising an admixture of:
a cationic polyelectrolyte, an anionic polyelectrolyte, nanostructures, and, a crosslinking agent;
a curing solution comprising a volatile buffering agent; and
instructions for applying the coating solution to a substrate and allowing the applied coating solution to dry before then applying the curing solution to cure the coating solution into a coating under ambient conditions.
